(19) United States
(12) Patent Application Publication
(10) Pub. No.: US 2026/0246800 A1
(43) Pub. Date: Aug. 20, 2026

(54) SYSTEMS AND METHODS FOR INTELLIGENT IDENTIFICATION AND AUTOMATED DISPOSAL OF NON-MALICIOUS IDENTITY ALERTS

(71) Applicant: Expel, Inc., Herndon, VA (US)

(72) Inventors: Liz McLaughlin, Harrisburg, PA (US); Brian Badorrek, Raleigh, NC (US); Ian Cooper, Portland, OR (US); Jane Hung, Raleigh, NC (US)

(73) Assignee: Expel, Inc., Herndon, VA (US)

(21) Appl. No.: 19/541,250

(22) Filed: Feb. 16, 2026

Related U.S. Application Data
(60) Provisional application No. 63/939,238, filed on Dec. 12, 2025.
(60) Provisional application No. 63/760,286, filed on Feb. 19, 2025.

(51) Int. Cl. H04L 9/40

(52) U.S. Cl. CPC H04L 63/1425; H04L 63/1441

(57) ABSTRACT

A system, method, and computer-implemented method includes obtaining an identity alert, generating an identity alert feature vector for the identity alert based in part on alert data corresponding to the identity alert, computing, using a first identity alert machine learning classification model, a first identity alert threat inference that includes a probability of the identity alert being a non-malicious identity alert, computing, using a second identity alert machine learning classification model, a second identity alert threat inference that includes a probability of the identity alert being a benign identity alert, electing one of the first identity alert threat inference and the second identity alert threat inference as a dominant identity alert threat inference for the identity alert, and executing, based on the dominant identity alert threat inference, one or more identity alert threat mitigation actions or one or more identity alert disposal actions for the identity alert.

### CROSS-REFERENCE TO RELATED APPLICATIONS

This application claims the benefit of US Provisional Application number 63/939,238, filed 12-DEC-2025 and US Provisional Application number 63/760,286, filed 19-FEB-2025, which are incorporated in their entireties by this reference.

### TECHNICAL FIELD

This invention relates generally to the cybersecurity field, and more specifically to new and useful cyber threat detection and mitigation systems and methods in the cybersecurity field.

### BACKGROUND

Modern computing and organizational security have been evolving to include a variety of security operation services that can often abstract a responsibility for monitoring and detecting threats in computing and organizational resources of an organizational entity to professionally managed security service providers outside of the organizational entity. As many of these organizational entities continue to migrate their computing resources and computing requirements to cloud-based services, the security threats posed by malicious actors appear to grow at an incalculable rate because cloud-based services may be accessed through any suitable Internet or web-based medium or device throughout the world.

Thus, security operation services may be tasked with mirroring the growth of these security threats and correspondingly, scaling their security services to adequately protect the computing and other digital assets of a subscribing organizational entity. However, because the volume of security threats may be great, it may present one or more technical challenges in scaling security operations services without resulting in a number of technical inefficiencies that may prevent or slow down the detection of security threats and efficiently responding to detected security threats.

Thus, there is a need in the cybersecurity field to create improved systems and methods for intelligently scaling threat detection capabilities of a security operations service while improving its technical capabilities to efficiently respond to an increasingly large volume of security threats to computing and organizational computing assets. The embodiments of the present application described herein provide technical solutions that address, at least the need described above.

### BRIEF SUMMARY OF THE EMBODIMENTS

In one embodiment, a computer-implemented method includes obtaining, using one or more processors, an identity alert associated with a subscribing entity; generating, in response to obtaining the identity alert, an identity alert feature vector for the identity alert based in part on alert data corresponding to the identity alert; computing, using an ensemble of identity alert machine learning classification models, a plurality of distinct identity alert threat inferences for the identity alert based on providing the identity alert feature vector as input to each identity alert machine learning classification model included in the ensemble of identity alert machine learning classification models, wherein computing the plurality of distinct identity alert threat inferences includes: computing, using a first identity alert machine learning classification model of the ensemble of identity alert machine learning classification models, a first identity alert threat inference that includes a probability of the identity alert being a non-malicious identity alert, and computing, using a second identity alert machine learning classification model of the ensemble of identity alert machine learning classification models, a second identity alert threat inference that includes a probability of the identity alert being a benign identity alert; electing, using the one or more processors, one of the first identity alert threat inference and the second identity alert threat inference as a dominant identity alert threat inference for the identity alert based on assessing the probability of the identity alert being the non-malicious identity alert against the probability of the identity alert being the benign identity alert; and in response to electing the one of the first identity alert threat inference and the second identity alert threat inference as the dominant identity alert threat inference, automatically executing, based on the dominant identity alert threat inference, one or more identity alert threat mitigation actions or one or more identity alert disposal actions for the identity alert in real-time or near real-time.

In one embodiment, the dominant identity alert threat inference corresponds to the first identity alert threat inference when the probability of the identity alert being the non-malicious identity alert is greater than the probability of the identity alert being the benign identity alert.

In one embodiment, the dominant identity alert threat inference corresponds to the second identity alert threat inference when the probability of the identity alert being the benign identity alert is greater than the probability of the identity alert being the non-malicious identity alert.

In one embodiment, the dominant identity alert threat inference corresponds to the first identity alert threat inference, the probability of the identity alert being the non-malicious identity alert fails to satisfy a predetermined minimum threshold, and automatically executing the one or more identity alert threat mitigation actions or the one or more identity alert disposal actions for the identity alert includes executing the one or more identity alert threat mitigation actions based on detecting that the probability of the identity alert being the non-malicious identity alert fails to satisfy the predetermined minimum threshold, wherein executing the one or more identity alert threat mitigation actions includes: attributing, based on the probability of the identity alert being the non-malicious identity alert, a threat severity classification label of a plurality of predetermined threat severity classification labels to the identity alert; and displaying the identity alert in association with the threat severity classification label on a graphical user interface.

In one embodiment, the identity alert specifies a user account, and executing the one or more identity alert threat mitigation actions further includes: detecting, based on an assessment of the graphical user interface, that the user account is compromised, and in response to detecting that the user account is compromised, automatically disabling, in real-time or near real-time, the user account to prevent unauthorized access to one or more computing environments of the subscribing entity using the user account.

In one embodiment, the identity alert specifies a user account, and executing the one or more identity alert threat mitigation actions further includes detecting, based on an assessment of the graphical user interface, that the user account is compromised, and in response to detecting that the user account is compromised, automatically resetting, in real-time or near real-time, one or more authentication credentials of the user account to mitigate an active security threat involving the user account within one or more computing environments of the subscribing entity.

In one embodiment, the graphical user interface further includes an identity alert explainability user interface object displayed in association with the identity alert, wherein the identity alert explainability user interface object includes: a plurality of prevalence-based threat indicators derived from the identity alert, a plurality of authentication-based threat indicators derived from the identity alert, and a plurality of behavioral-based threat indicators derived from the identity alert.

In one embodiment, the computer-implemented method further includes: detecting, using the one or more processors, that at least one threat indicator included in the plurality of prevalence-based threat indicators, the plurality of authentication-based threat indicators, or the plurality of behavioral-based threat indicators indicates malicious activity; detecting, using the one or more processors, that at least one threat indicator included in the plurality of prevalence-based threat indicators, the plurality of authentication-based threat indicators, or the plurality of behavioral-based threat indicators indicates suspicious activity; and detecting, using the one or more processors, that at least one threat indicator included in the plurality of prevalence-based threat indicators, the plurality of authentication-based threat indicators, or the plurality of behavioral-based threat indicators indicates benign activity, wherein the graphical user interface displays: the at least one threat indicator indicative of malicious activity in a first distinct color when the at least one threat indicator indicates malicious activity, the at least one threat indicator indicative of suspicious activity in a second distinct color when the at least one threat indicator indicates suspicious activity, and the at least one threat indicator indicative of benign activity in a third distinct color when the at least one threat indicator indicates benign activity.

In one embodiment, the dominant identity alert threat inference corresponds to the second identity alert threat inference, the probability of the identity alert being the benign identity alert satisfies a predetermined minimum threshold, and automatically executing the one or more identity alert threat mitigation actions or the one or more identity alert disposal actions for the identity alert includes executing the one or more identity alert disposal actions based on detecting that the probability of the identity alert being the benign identity alert satisfies the predetermined minimum threshold, wherein executing the one or more identity alert disposal actions includes: automatically closing, in real-time, the identity alert to prevent a security analyst from at least one of investigating, reviewing, and escalating the identity alert, and automatically attributing, in real-time, a close reason to the identity alert indicating that the identity alert is benign.

In one embodiment, the computer-implemented method further includes detecting, in response to assessing the dominant identity alert threat inference, that the identity alert is eligible to be automatically closed; in response to detecting that the identity alert is eligible to be automatically closed, assessing the identity alert feature vector against one or more post-processing rules; detecting, in response to assessing the identity alert feature vector against the one or more post-processing rules, that at least one feature value corresponding to at least one feature included in the identity alert feature vector is suspicious; and preventing automatic closure of the identity alert based on detecting that the at least one feature value corresponding to the at least one feature is suspicious.

In one embodiment, the computer-implemented method further includes: obtaining, from a computer database, an initial set of historical identity alerts that occurred in a target period; extracting, from the initial set of historical identity alerts, (i) a first subset of malicious historical identity alerts that includes all malicious identity alerts that occurred in the target period and (ii) a second subset of non-malicious historical identity alerts that includes all non-malicious identity alerts that occurred in the target period; executing, on the second subset of non-malicious historical identity alerts, a stratified sampling process to generate a reduced subset of historical non-malicious identity alerts; configuring a training data corpus that includes the first subset of malicious historical identity alerts and the reduced subset of historical non-malicious identity alerts, wherein: each malicious identity alert included in the first subset of malicious historical identity alerts is attributed a malicious identity alert classification label, and each non-malicious identity alert included in the reduced subset of historical non-malicious identity alerts is attributed a non-malicious identity alert classification label; and configuring the first identity alert machine learning classification model based on a training of an extreme gradient boosting (XGboost) machine learning model using the training data corpus.

In one embodiment, the training data corpus is configured such that a ratio of non-malicious identity alerts to malicious identity alerts included in the training data corpus is three to one.

In one embodiment, the target period corresponds to a target year, the reduced subset of historical non-malicious identity alerts includes a first set of historical non-malicious identity alerts that occurred in a first month of the target year, a second set of historical non-malicious identity alerts that occurred in a second month of the target year, a third set of historical non-malicious identity alerts that occurred in a third month of the target year, a fourth set of historical non-malicious identity alerts that occurred in a fourth month of the target year, a fifth set of historical non-malicious identity alerts that occurred in a fifth month of the target year, a sixth set of historical non-malicious identity alerts that occurred in a sixth month of the target year, a seventh set of historical non-malicious identity alerts that occurred in a seventh month of the target year, an eighth set of historical non-malicious identity alerts that occurred in an eighth month of the target year, a ninth set of historical non-malicious identity alerts that occurred in a ninth month of the target year, a tenth set of historical non-malicious identity alerts that occurred in a tenth month of the target year, an eleventh set of historical non-malicious identity alerts that occurred in an eleventh month of the target year, and a twelfth set of historical non-malicious identity alerts that occurred in a twelfth month of the target year, and a total number of non-malicious identity alerts included in the reduced subset that occurred in a respective month of the target year is equal to a total number of non-malicious identity alerts included in the reduced subset that occurred in any other month of the target year.

In one embodiment, the computer-implemented method further includes: obtaining, from a computer database, an initial set of historical identity alerts that occurred in a target period; extracting, from the initial set of historical identity alerts, (i) a first subset of not benign historical identity alerts that includes all identity alerts that occurred in the target period that were determined to be not benign alerts and (ii) a second subset of benign historical identity alerts that includes all identity alerts that occurred in the target period that were determined to be benign alerts; executing, on the second subset of benign historical identity alerts, a stratified sampling process to generate a reduced subset of benign historical identity alerts; configuring a training data corpus that includes the first subset of not benign historical identity alerts and the reduced subset of benign historical identity alerts, wherein: each identity alert included in the first subset of not benign historical identity alerts is attributed a not benign identity alert classification label, and each identity alert included in the reduced subset of benign historical identity alerts is attributed a benign identity alert classification label; and configuring the second identity alert machine learning classification model based on a training of an extreme gradient boosting (XGboost) machine learning model using the training data corpus.

In one embodiment, the training data corpus is configured such that a ratio of benign identity alerts to not benign identity alerts included in the training data corpus is three to one, the target period corresponds to a target year, the reduced subset of benign historical identity alerts includes a distinct set of benign identity alerts that occurred in each month of the target year, and a total number of benign identity alerts included in the reduced subset that occurred in a respective month of the target year is equal to a total number of benign identity alerts included in the reduced subset that occurred in any other month of the target year.

In one embodiment, the identity alert is associated with a digital user, the identity alert feature vector includes: a feature value for a first feature, wherein the feature value for the first feature specifies a total number of unique days, during a historical time span, that the digital user successfully logged into a computing environment of the subscribing entity from an internet protocol address specified in the identity alert, a feature value for a second feature, wherein the feature value for the second feature specifies an authentication success rate observed for the digital user during the historical time span, a feature value for a third feature, wherein the feature value for the third feature specifies a total number of unique users, during the historical time span, that successfully authenticated into the computing environment of the subscribing entity from the internet protocol address specified in the identity alert, and a feature value for a fourth feature, wherein the feature value for the fourth feature specifies a total number of times, during the historical time span, that the digital user successfully authenticated into the computing environment from a geographical location determined based on the internet protocol address specified in the identity alert.

In one embodiment, the identity alert is associated with a digital user, the computer-implemented method further comprises: detecting, by the one or more processors, that the digital user used a virtual private network while logging into a computing environment of the subscribing entity; determining, by the one or more processors, a total number of times, during a historical time span, that the digital user successfully authenticated to the computing environment from the virtual private network; and determining, by the one or more processors, a total number of unique digital users that have successfully authenticated into the computing environment from the virtual private network during the historical time span, and the identity alert feature vector includes: a feature value for a first feature, wherein the feature value for the first feature specifies the total number of times, during the historical time span, that the digital user successfully authenticated to the computing environment from the virtual private network, and a feature value for a second feature, wherein the feature value for the second feature specifies the total number of unique digital users that have successfully authenticated into the computing environment from the virtual private network during the historical time span.

In one embodiment, the identity alert is associated with a digital user, the computer-implemented method further comprises: identifying, based on assessing log data associated with the subscribing entity, one or more deletion events attributable to the digital user that occurred during a historical time span, wherein each deletion event of the one or more deletion events corresponds to a distinct action by the digital user that removes, destroys, or eliminates data within a computing environment of the subscribing entity; determining, based on the one or more deletion events, a total number of deletion events attributable to the digital user during the historical time span, and the identity alert feature vector includes: a feature value for a subject feature, wherein the feature value for the subject feature specifies the total number of deletion events attributable to the digital user during the historical time span.

In one embodiment, the identity alert is associated with a user, the computer-implemented method further comprises: automatically determining, based on assessing log data associated with the subscribing entity, whether one or more travel-related indicators for the user appear in the log data; computing, based on the automatic determining, a feature value for a user travel details feature, wherein: the feature value for the user travel details feature is one when at least one travel-related text string for the user is detected in the log data, and the feature value for the user travel details feature is zero when no travel-related text string for the user is detected in the log data, and the identity alert feature vector includes the feature value for the user travel details feature.

In one embodiment, the identity alert is associated with a digital user, the computer-implemented method further comprises: detecting, based on assessing log data associated with the subscribing entity, that the digital user created at least one electronic inbox rule during a predetermined time span; assessing, in response to detecting that the digital user created the at least one electronic inbox rule during the predetermined time span, whether the at least one electronic inbox rule satisfies a suspicious electronic inbox rule criterion; and computing, based on the assessing of the at least one electronic inbox rule, a feature value for a suspicious electronic inbox rule creation feature, wherein: the feature value for the suspicious electronic inbox rule creation feature is one when the at least one electronic inbox rule satisfies the suspicious electronic inbox rule criterion, and the feature value for the suspicious electronic inbox rule creation feature is zero when the at least one electronic inbox rule fails to satisfy the suspicious electronic inbox rule criterion, and the identity alert feature vector includes the feature value for the suspicious electronic inbox rule creation feature.

In one embodiment, the identity alert is associated with a user, the computer-implemented method further comprises: obtaining, based on assessing authentication log data associated with the subscribing entity, a plurality of login events corresponding to the user that occurred within a predetermine time span; constructing, based on obtaining the plurality of login events, an authentication event sequence data structure for the user that includes the plurality of login events in chronological order; assessing at least one pair of sequential login events included in the authentication event sequence data structure to determine whether travel between (i) a first distinct geographical location associated with a first login event included in the at least one pair of sequential login events and (ii) a second distinct geographic location associated with a second login event included in the at least one pair of sequential login events is physically possible based on an amount of time elapsed between the first login event and the second login event; computing, based on the assessing, a feature value for a subject feature, wherein: the feature value of the subject feature is one when the at least one pair of sequential login events requires travel by the user from the first distinct geographical location to the second distinct geographic location at a speed that exceeds a predetermined maximum travel speed threshold, and the feature value of the subject feature is zero when the at least one pair of sequential login events requires travel by the user from the first distinct geographical location to the second distinct geographic location at the speed that does not exceed the predetermined maximum travel speed threshold, and the identity alert feature vector includes the feature value for the subject feature.

In one embodiment, a model structure of the first identity alert machine learning classification model is different from a model structure of the second identity alert machine learning classification model, and a set of weights and biases used by the first identity alert machine learning classification model to compute the probability of the identity alert being the non-malicious identity alert is different from a set of weights and biases used by the second identity alert machine learning classification model to compute the probability of the identity alert being the benign identity alert.

In one embodiment, the training data corpus is configured such that a total number of non-malicious identity alerts included in the training data corpus is at least three times greater than a total number of malicious identity alerts included in the training data corpus.

### BRIEF DESCRIPTION OF THE FIGURES

FIG. 1 illustrates a schematic representation of a system 100 in accordance with one or more embodiments of the present application;

FIG. 2 illustrates an example method 200 in accordance with one or more embodiments of the present application;

FIG. 3 illustrates an example schematic of using an ensemble of machine learning models to determine an alert handling action for a subject identity alert in accordance with one or more embodiments of the present application;

FIG. 4 illustrates an example of using a dominant identity alert inference to control whether the identity alert corresponding to the dominant identity alert inference should be closed or routed to an alert queue for triage;

FIG. 5 illustrates an example set of threat severity classification labels attributable to an identity alert;

FIG. 6 illustrates an example close reason in accordance with one or more embodiments of the present application;

FIG. 7 illustrates example alert classifications in accordance with one or more embodiments of the present application; and

FIGS. 8 - 9 illustrate example graphical user interfaces in accordance with one or more embodiments of the present application.

### DESCRIPTION OF THE PREFERRED EMBODIMENTS

The following description of the preferred embodiments of the inventions are not intended to limit the inventions to these preferred embodiments, but rather to enable any person skilled in the art to make and use these inventions.

### 1. System for Remote Cyber Security Operations & Automated Investigations

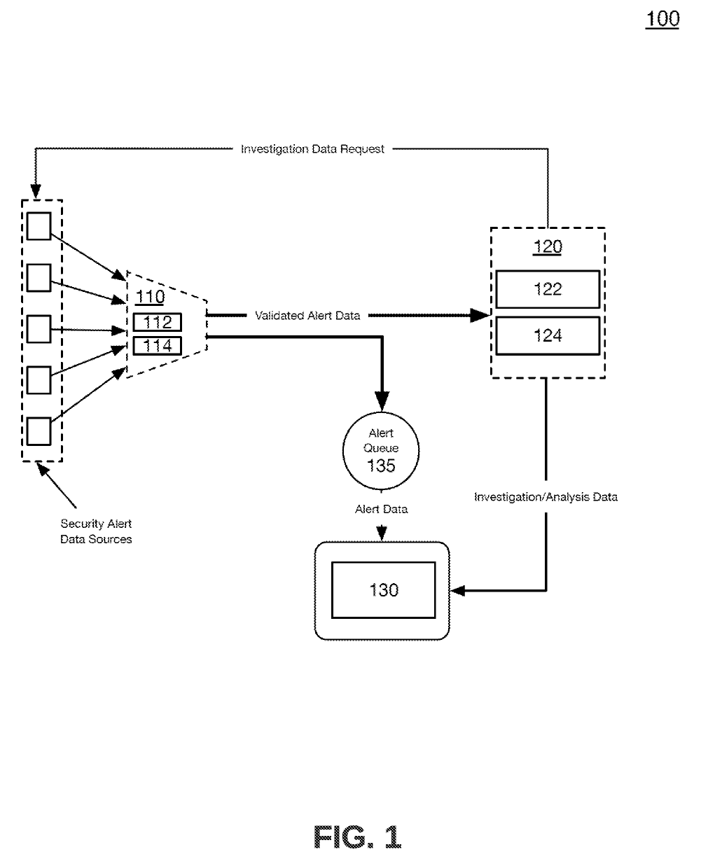

As shown in FIG. 1, a system 100 for implementing remote cybersecurity operations includes a security alert engine 110, an automated security investigations engine 120, and a security threat mitigation user interface 130. The system 100 may sometimes be referred to herein as a cybersecurity threat detection and threat mitigation system, a cybersecurity event detection and response service, or an identity threat detection and response service.

The system 100 may function to enable real-time cybersecurity threat detection, agile, and intelligent threat response for mitigating detected security threats.

### 1.1 Security Alert Engine

The security alert aggregation and identification module 110, sometimes referred to herein as the “security alert engine 110” may be in operable communication with a plurality of distinct sources of cyber security alert data. In one or more embodiments, the module 110 may be implemented by an alert application programming interface (API) that may be programmatically integrated with one or more APIs of the plurality of distinct sources of cyber security alert data and/or native APIs of a subscriber to a security service implementing the system 100.

In one or more embodiments, the security alert engine 110 may include a security threat detection logic module 112 that may function to assess inbound security alert data using predetermined security detection logic that may validate or substantiate a subset of the inbound alerts as security threats requiring an escalation, an investigation, and/or a threat mitigation response by the system 100 and/or by a subscriber to the system 100.

Additionally, or alternatively, the security alert engine 100 may function as a normalization layer for inbound security alerts from the plurality of distinct sources of security alert data by normalizing all alerts into a predetermined alert format.

### 1.1.1 Security Alert Machine Learning Classifier

Optionally, or additionally, the security alert engine 110 may include a security alert machine learning system 114 that may function to classify inbound security alerts as validated or not validated security alerts, as described in more detail herein.

The security alert machine learning system 114 may implement a single machine learning algorithm or an ensemble of machine learning algorithms. Additionally, the security alert machine learning system 114 may be implemented by the one or more computing servers, computer processors, and the like of the artificial intelligence virtual assistance platform 110.

The machine learning models and/or the ensemble of machine learning models of the security alert machine learning system 114 may employ any suitable machine learning including one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system 100. Further, any suitable model (e.g., machine learning, non-machine learning, etc.) may be used in implementing the security alert machine learning system 114 and/or other components of the system 100.

### 1.2 Automated Investigations Engine

The automated security investigations engine 120, which may be sometimes referred to herein as the “investigations engine 120”, preferably functions to automatically perform investigative tasks for addressing a security task and/or additionally, resolve a security alert. In one or more embodiments, the investigations engine 120 may function to automatically resolve a security alert based on results of the investigative tasks.

In one or more embodiments, the investigations engine 120 may include an automated investigation workflows module 122 comprising a plurality of distinct automated investigation workflows that may be specifically configured for handling distinct security alert types or distinct security events. Each of the automated investigation workflows preferably includes a sequence of distinct investigative and/or security data production tasks that may support decisioning on or a disposal of a validated security alert. In one or more embodiments, the investigations engine 120 may function to select or activate a given automated investigation workflow from among the plurality of distinct automated investigation workflows based on an input of one or more of validated security alert data and a security alert classification label.

Additionally, or alternatively, the investigations engine 120 may include an investigations instructions repository 124 that includes a plurality of distinct investigation instructions/scripts or investigation rules that inform or define specific investigation actions and security data production actions for resolving and/or addressing a given validated security alert. In one or more embodiments, the investigations instructions repository 124 may be dynamically updated to include additional or to remove one or more of the plurality of distinct investigation instructions/scripts or investigation rules.

### 1.3 Security Threat Mitigation User Interface

The security mitigation user interface 130 (e.g., Workbench) may function to enable an analyst or an administrator to perform, in a parallel manner, monitoring, investigations, and reporting of security incidents and resolutions to subscribers to the system 100 and/or service implementing the system 100. In some embodiments, an operation of the security user interface 130 may be transparently accessible to subscribers, such that one or more actions in monitoring, investigation, and reporting security threats or security incidents may be surfaced in real-time to a user interface accessible to a subscribing entity.

Accordingly, in or more embodiments, a system user (e.g., an analyst) or an administrator implementing the security mitigation user interface 130 may function to make requests for investigation data, make requests for automated investigations to the automated investigations engine 120, obtain security incident status data, observe or update configuration data for automated investigations, generate investigation reports, and/or interface with any component of the system 100 as well as interface with one or more systems of a subscriber.

Additionally, or alternatively, in one or more embodiments, the security mitigation user interface 130 may include and/or may be in digital communication with a security alert queue 135 that stores and prioritizes validated security alerts.

### 2. Method for Intelligent Identification and Automated Disposal of Non-Malicious Identity Alerts

The systems, methods, and embodiments described herein may be used in a variety of technology areas where security alerts (e.g., identity alerts, etc.) need to be assessed in real-time or near real-time to prevent or mitigate unauthorized access, identity misuse, account compromise, or other identity-related security risks within one or more computing environments of a subscribing entity (e.g., subscriber or the like). The security alerts may be generated by the systems, methods, and embodiments described herein and/or may be generated by one or more external identity providers, authentication services, access-management systems, or other identity-related security systems.

In such technology areas, a high volume of identity alerts (e.g., more than one thousand identity alerts, more than five hundred thousand identity alerts, more than one million identity alerts, etc.) may be generated over short periods of time, and a majority of the identity alerts may correspond to non-malicious or benign activity. Investigating each identity alert, even though the majority of the identity alerts may correspond to non-malicious or benign activity, may unnecessarily increase the total number of security alerts awaiting processing (e.g., review, triaging or the like) within an alert queue, thereby delaying detection and threat mitigation response to identity alerts associated with actual security threats. Accordingly, the systems, methods, and embodiments described herein, may prevent the unnecessary increase in the alert queue backlog (e.g., the total number of identity alerts awaiting processing, review, triaging, investigation, or the like within the alert queue) by automatically disposing of, closing, otherwise resolving identity alerts determined to correspond to non-malicious or benign activity, while prioritizing or escalating identity alerts associated with potential security threats.

At least one technical advantage of the systems, methods, and embodiments described herein includes accelerating identity alert assessment and response by automatically identifying and disposing of identity alerts determined to correspond to non-malicious or benign activity in real-time or near real-time. By reducing the number of identity alerts that require triaging and/investigation within an alert queue, the systems, methods, and embodiments described herein decrease alert handling latency and enable accelerated detection and mitigation of identity alerts associated with actual security threats.

At least one technical advantage of the systems, methods, and embodiments described herein includes accelerating identity alert assessment and response by automatically evaluating identity alerts in real-time or near real-time using one or more machine learning models prior to placement of the identity alerts within an alert queue. By assessing identity alerts before they are queued, the systems, methods, and embodiments described herein prevent identity alerts determined to correspond to non-malicious or benign activity from unnecessarily entering the alert queue.

Another technical advantage of the systems, methods, and embodiments described herein includes reducing alert queue backlog by preventing non-malicious or benign identity alerts from being added to the alert queue. By automatically disposing of, closing, or otherwise resolving such identity alerts prior to being routed to the alert queue, the systems, methods, and embodiments described herein reduce the total number of identity alerts awaiting processing within the alert queue.

Another technical advantage of the systems, methods, and embodiments described herein includes improving the efficiency and scalability of identity threat detection and response systems operating in high-volume alert environments. By using machine learning to assess identity alerts as they are generated and/or obtained and selectively enqueuing only identity alerts associated with potential security threats, the systems, methods, and embodiments described herein enable identity threat detection systems to maintain low alert processing latency as alert volumes increase.

Another technical advantage of the systems, methods, and embodiments described herein includes reducing unnecessary consumption of computing and system resources associated with downstream alert handling. By preventing non-malicious or benign identity alerts from progressing through alert queue processing, review, or automated investigation workflows, the systems, methods, and embodiments described herein enable computing resources to only be allocated toward identity alerts associated with unauthorized access, identity misuse, or other identity-based security threats.

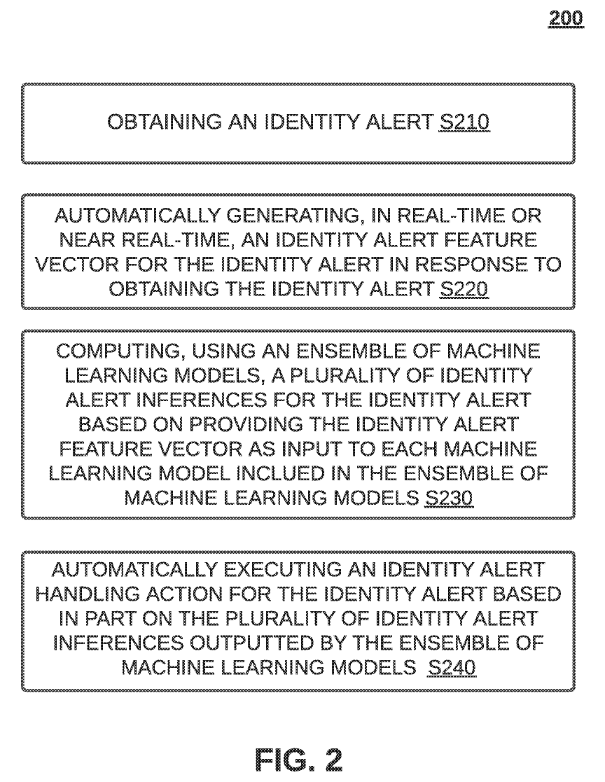

As shown in FIG. 2, a method 200 for intelligent identification and automated disposal of non-malicious identity alerts may include obtaining an identity alert S210, automatically generating, in real-time or near real-time, an identity alert feature vector for the identity alert in response to obtaining the identity alert S220, computing, using an ensemble of machine learning models, a plurality of identity alert inferences for the identity alert based on providing the identity alert feature vector as input to each machine learning model included in the ensemble of machine learning models S230, and automatically executing an identity alert handing action for the identity alert based in part on the plurality of identity alert inferences generated by the ensemble of machine learning models S240.

### 2.10 Obtaining an Identity Alert

S210, which includes obtaining an identity alert, may function to obtain, in real-time or near real-time, an identity alert associated with a subscribing entity subscribing to the identity threat detection and response service. An identity alert, as generally referred to herein, may be a type of security alert that is generated in response to detecting that activity involving or associated with a digital identity (e.g., digital user, user identity, etc.) appears suspicious, unauthorized, or otherwise indicative of a potential security threat. It shall be recognized that the term “identity alert” may be interchangeably referred to herein as a “security alert,” an “identity-based alert,” an “identity-based security alert,” and/or the like without departing from the scope of the disclosure.

In one or more embodiments, the system or service implementing method 200 may function to receive, from one or more third-party identity services (e.g., Okta®, Duo®, Azure ID®, etc.), telemetry data (e.g., event data, log data, user authentication data, application access data, user context data, etc.) associated with a target subscriber and, in turn, S210 may function to generate an identity alert based on assessing the telemetry data associated with the target subscriber. Accordingly, in such an embodiment, in response to receiving the telemetry data, the system or service implementing method 200 may function to assess the telemetry data obtained from the one or more third-party identity services against one or more identity-based threat detection instructions and, in turn, generate, in real-time or near real-time, an identity alert (e.g., identity-based alert or the like) in response to assessing the telemetry data against the one or more identity-based threat detection instructions.

Stated another way, in one or more embodiments, the system or service implementing method 200 may obtain telemetry data from one or more identity, authentication, or access management systems or services. The telemetry data may include data streams, logs, event data, and/or alert data that may include a representation of digital actions, digital events, or digital behaviors performed by one or more digital identities (e.g., digital users, etc.) within a computing environment of a target subscriber. Accordingly, in such an embodiment, the system or service implementing method 200 may function to generate an identity-based alert based on detecting one or more pieces of data included in the telemetry data that satisfies alerting criteria of at least one of the one or more identity-based threat detection instructions.

Additionally, or alternatively, in one or more embodiments, the system or service implementing method 200 may function to obtain, from one or more third-party identity, authentication, or access management services, a raw identity alert involving a digital identity (e.g., digital user) of a target subscriber and, in turn, the system or service implementing method 200 may function to normalize or convert the raw identity alert to an identity alert compatible with the identity threat detection and response service. In other words, the identity alert compatible with the identity threat detection and response service may conform to a target alert data schema specified by the identity threat detection and response service.

Additionally or alternatively, in one or more embodiments, the system or service implementing method 200 may function to retrieve telemetry data (e.g., raw event data, etc.), one or more raw identity alerts, and/or any other suitable piece of identity data from the one or more third-party identity, authentication, or access management services by performing a polling task, as described in U.S. Patent No. 12,530,450, titled SYSTEMS AND METHODS FOR AUTOMATICALLY TUNING ONE OR MORE API POLLERS IN A CYBERSECURITY EVENT DETECTION AND RESPONSE SERVICE, which is incorporated herein in its entirety by this reference. In other words, the system or service implementing method 200 may function to generate a polling task that is configured to retrieve raw event data (e.g. telemetry data) and raw identity alerts that occurred during a target time span from the one or more third-party identity, authentication, or access management services and, in turn, transmit a plurality of distinct network requests to an endpoint of the one or more third-party identity, authentication, or access management services to perform the polling task to obtain the raw event data and/or the raw identity alerts that occurred during the target time span.

It shall be recognized that, in one or more embodiments, a respective identity-based alert generated or obtained by the system or service implementing method 200 may have an unknown degree of threat severity. As described in more detail herein, the system or service implementing method 200 may function to use one or more machine learning models (e.g., an ensemble of XGBoost machine learning models, an ensemble of machine learning-based classification models, etc.) to accelerate a triaging or remediation of the respective identity-based alert.

### Example Identity-Based Alerts

In one or more embodiments, an identity-based alert obtained or generated by the system or service implementing method 200 may be associated with a digital user of a subscribing entity having anomalous authentication activity (e.g., a login attempt from an unusual geolocation or unrecognized device).

Additionally, or alternatively, in one or more embodiments, an identity-based alert obtained or generated by the system or service implementing method 200 may be associated with a digital user of a subscribing entity having multiple failed authentication attempts.

Additionally, or alternatively, in one or more embodiments, an identity-based alert obtained or generated by the system or service implementing method 200 may be associated with a digital user of a subscribing entity having concurrent login activity from multiple geographically disparate locations.

Additionally, or alternatively, in one or more embodiments, an identity-based alert obtained or generated by the system or service implementing method 200 may be associated with a digital user of a subscribing entity having an elevation of privileges or modification of user roles inconsistent with the digital user’s historical access behavior.

Additionally, or alternatively, in one or more embodiments, an identity-based alert obtained or generated by the system or service implementing method 200 may be associated with a digital user of a subscribing entity accessing a sensitive application, system resource, or dataset outside of the digital user’s normal usage patterns or authorized access scope.

Additionally, or alternatively, in one or more embodiments, an identity-based alert obtained or generated by the system or service implementing method 200 may be associated with a digital user of a subscribing entity exhibiting anomalous multifactor authentication behavior, such as repeated failed MFA attempts or successful authentication from an unrecognized MFA device.

It shall be recognized that other types of identity-based alerts may be obtained or generated by the system or service implementing method 200 without departing from the scope of the disclosure.

### 2.20 Extracting one or more Identity Alert Feature Vectors from the Identity Alert

S220, which includes extracting one or more identity alert feature vectors, may function to extract, in real-time or near real-time, one or more identity alert feature vectors from the identity alert obtained by S210. In one or more embodiments, an identity alert feature vector generated for a respective identity alert may include a structured collection of one or more numerical features, one or more categorical features, one or more binary features, and/or one or more enriched features that represents the respective identity alert in a machine-readable format suitable for input into one or more machine learning models. It shall be recognized that the term “identity alert feature vector” may be interchangeably referred to herein as a “feature vector,” an “a corpus of features,” and/or the like without departing from the scope of the disclosure.

In one or more embodiments, S210 may function to obtain or generate a high volume of identity alerts (e.g., 1,000 identity alerts, etc.), wherein at least a subset (e.g., 500 identity alerts of the 1,000 identity alerts, 520 identity alerts of the 1,000 identity alerts) of the high volume of identity alerts are typically non-malicious, benign, and/or not indicative of a true security threat. The subset of the high volume of identity alerts, in such an embodiment, may unnecessarily contribute to an increase in the number of pending security alerts within an alert queue, thereby causing one or more security analysts of the identity threat detection and response service to manually triage and/or perform a security investigation for each identity alert of the subset.

Stated another way, in such an embodiment, five (5) percent or more, ten (10) percent or more, fifteen (15) percent or more, twenty (20) percent or more, twenty-five (25) percent or more, thirty (30) percent or more, thirty-five (35) percent or more of the plurality of the identity-based alerts generated or obtained by the system or service implementing method 200 may be benign or not malicious. This may result in increased noise within the alert queue, which may make it difficult for analysts to properly assess and remediate malicious alerts, thus leading to analyst burnout. Stated another way, routing each identity-based alert of the subset of the high volume of identity alerts to an alert queue may cause an unnecessary increase in security alerts pending within the alert queue (i.e., the security alert queue) as the subset of identity alerts are not malicious.

Accordingly, at least one technical benefit of extracting the one or more identity alert feature vectors from a respective identity alert may enable one or more downstream machine learning models (e.g., an ensemble of XGBoost machine learning models, an ensemble of machine learning-based classification models, etc.) to predict (on a per-alert basis) a likely threat severity class from a plurality predetermined threat severity classes (e.g., malicious, suspicious, likely benign, benign, or inconclusive) for the respective identity alert and, when appropriate, automatically close the respective identity alert when the one or more machine learning models predicts the respective identity alert is benign.

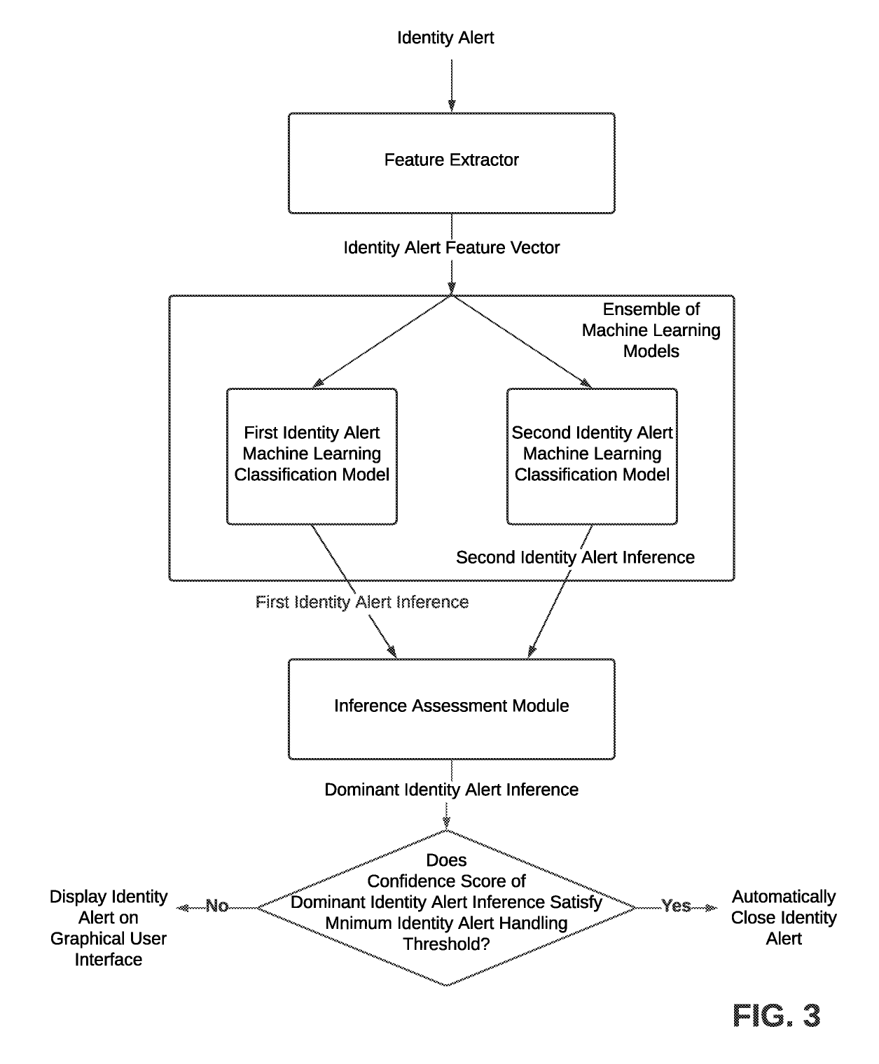

It shall be recognized that, in one or more embodiments, S220 may function to use a feature extractor or a feature extractor system to extract an identity alert feature vector from a target identity-based alert, as shown generally by way of example in FIG. 3. The identity alert feature vector, in some embodiments, may include five or more distinct features associated with the target identity-based alert, ten or more distinct features associated with the target identity-based alert, twenty or more distinct features associated with the target identity-based alert, thirty or more distinct features associated with the target identity-based alert, forty or more distinct features associated with the target identity-based alert, fifty or more distinct features associated with the target identity-based alert, one hundred or more distinct features associated with the target identity-based alert, etc., as described in more detail herein.

Stated another way, in one or more embodiments, the system or service implementing method 200 may obtain, using one or more processors, an identity alert associated with a subscribing entity and, in response, generate an identity alert feature vector for the identity alert based in part on alert data corresponding to the identity alert.

It shall be recognized that, in one or more embodiments, the predetermined time span, the historical time span, or the like described herein may be defined relative to a clock time at which the system or service implementing method 200 received, obtained, or generated the subject identity alert. For example, if the subject identity alert is received at a clock time corresponding to Jan. 31, 2024 at 12:00 p.m. (UTC), a predetermined time span of thirty (30) days may correspond to a time interval beginning at Jan. 1, 2024 at 12:00 p.m. (UTC) and ending at Jan. 31, 2024 at 12:00 p.m. (UTC), and logs (e.g., log data) associated with the subscribing entity having timestamps that fall within the time interval may be used and/or assessed by the system or service implementing method 200 when computing the one or more feature values described herein.

It shall be further recognized that, in one or more embodiments, the identity alert feature vector generated for a subject identity alert may include feature values for a subset of the features described herein or feature values for all of the features described herein. For instance, in a non-limiting example, the identity alert feature vector generated for the subject identity alert, in one or more embodiments, may include the feature value of the internet protocol address user prevalence feature value computed for the subject identity alert, the feature value of the internet protocol address environment prevalence feature computed for the subject identity alert, the feature value of the internet protocol address organization prevalence feature computed for the subject identity alert, the feature value for the ASN prevalence feature computed for the subject identity alert, the feature value of the geographical region prevalence feature computed for the subject identity alert, the feature value of the VPN user prevalence feature computed for the subject identity alert, the feature value of the VPN environment prevalence feature computed for the subject identity alert, the feature value of the hosting user prevalence feature computed for the subject identity alert, the feature value of the deletion event feature computed for the subject identity alert, the feature value of the consecutive MFA failure feature computed for the subject identity alert, the feature value of the malicious attribute feature computed for the subject identity alert, the feature value of the MFA device IP association feature computed for the subject identity alert, the feature value for the valid MFA device feature computed for the subject identity alert, the feature value of the strong MFA device feature computed for the subject identity alert, the feature value of the weak MFA device feature computed for the subject identity alert, the feature value of the user agent feature computed for the subject identity alert, the feature value of the user travel details feature computed for the subject identity alert, the feature value of the suspicious electronic inbox rule creation feature computed for the subject identity alert, the feature value of the new MFA device registration feature computed for the subject identity alert, the feature value of the deletion events from user and IP address feature computed for the subject identity alert, the feature value of the geo-impossible travel feature computed for the subject identity alert, the feature value of the new user account feature computed for the subject identity alert, each feature value of the one or more electronic communication features computed for the subject identity alert, the feature value of the new user agent feature computed for the subject identity alert, and/or the feature value of any other feature described herein.

### Internet Protocol Address User Prevalence Feature

In one or more embodiments, S210 may function to obtain a subject identity alert associated with a subscribing entity subscribing to the identity threat detection and response service. The subject identity alert, in one or more embodiments, may include alert data specifying a digital user involved in the subject identity alert and an internet protocol address that the digital user used to access or attempt to access a target computing environment of the subscribing entity.

In one or more embodiments, in response to obtaining the subject identity alert, S220 may function to automatically compute, for the subject identity alert, an internet protocol address user prevalence feature value corresponding to the subject identity alert. It shall be recognized that, in one or more embodiments, the internet protocol address user prevalence feature value computed for the subject identity alert may also be referred to herein as the feature value for the internet protocol address user prevalence feature value.

In one or more embodiments of a first implementation, in response to obtaining the subject identity alert, S220 may function to automatically compute, for a predetermined time span (e.g., last 60 days, last 30 days, last 15 days, etc.), a total number of times the digital user has successfully authenticated into the target computing environment controlled by the subscribing entity. Stated another way, in some embodiments, S220 may function to compute, in real-time or near real-time, an aggregate count of successful authentication events indicating the total number of instances, within the preceding 30 days, in which the digital user successfully logged on to the target computing environment or any component system thereof from the internet protocol address specified in the subject identity alert.

It shall be recognized that, in one or more embodiments, S220 may function query one or more authentication logs, identity-management systems, or access-control databases to identify all successful login events associated with the digital user and originating from the internet protocol address specified in the subject identity alert during the predetermined time span. The system or service implementing method 200 may then aggregate, normalize, and/or deduplicate the identified successful login events to produce the resulting aggregate count. For instance, in a non-limiting example, the feature value of the internet protocol address user prevalence feature computed for the subject identity alert may include a numerical value indicating that the digital user successfully logged on to the target computing environment from the specified internet protocol address zero (0) times, five (5) times, or twenty (20) times during the predetermined time span, depending on the historical authentication data associated with the internet protocol address specified in the subject identity alert.

Additionally, or alternatively, in one or more embodiments, the system or service implementing method 200 may function to determine, in real-time or near real-time, a total number of unique days within the predetermined time span in which the digital user successfully logged on to the target computing environment or any component thereof from the internet protocol address specified in the subject identity alert. Stated another way, in some embodiments, S220 may function to compute, in real-time or near real-time, an aggregate count representing a total number of distinct calendar days within the predetermined time span in which at least one successful authentication event originating from the specified internet protocol address was attributed to the digital user. For instance, in a non-limiting example, the feature value of the internet protocol address user prevalence feature computed for the subject identity alert may include a count-based value of thirty (30) when the system or service implementing method 200 detects that the digital user successfully logged in to the target computing environment from the internet protocol address specified in the subject identity alert across or on thirty (30) distinct days within the predetermined time span.

In another non-limiting example, during the predetermined time span (e.g., thirty days), the digital user may have only successfully logged in to the target computing environment from (or using) the internet protocol address specified in the subject identity alert on two (2) distinct days of the predetermined time span—such as by logging in to the target computing environment fifteen (15) times on a first distinct day and twenty (20) times on a second distinct day. Accordingly, in such a non-limiting example, the feature value of the internet protocol address user prevalence feature computed for the subject identity alert may include a count-based value of two (2) based on the system or service implementing method 200 detecting that the digital user only logged in to the target computing environment from the internet protocol address specified in the subject identity alert on two (2) distinct days of the predetermined time span.

Additionally, or alternatively, in one or more embodiments, the feature value of the internet protocol address user prevalence feature computed for the subject identity alert may include an authentication success rate value that indicates a ratio between (i) the number of successful authentication events generated when the digital user attempted to log on to the target computing environment from or using the internet protocol address specified in the subject identity alert and (ii) the total number of authentication attempts (e.g., successful authentication attempts and failed authentication attempts) originating from the internet protocol address specified in the subject identity alert and attributable to the digital user during the predetermined time span. For instance, in a non-limiting example, the authentication success rate value may indicate a success ratio of seventy percent (70%) when the digital user generated seven (7) successful authentication events out of ten (10) total authentication attempts originating from the internet protocol address specified in the subject identity alert during the predetermined time span. In another non-limiting example, the authentication success rate value may indicate a success ratio of two and one-half percent (2.5%) when the digital user only successfully authenticated one (1) time to the target computing environment out of forty (40) total authentication attempts originating from the internet protocol address specified in the subject identity alert during the predetermined time span.

In one or more embodiments of a second implementation, in response to obtaining the subject identity alert, S210 may function to query a third-party identity service or the identity threat detection and response service based on the digital user involved in the subject identity alert and/or the internet protocol address specified in the subject identity alert and, in turn, receive historical authentication data that may specify a total number of times the digital user has successfully authenticated from the internet protocol address specified in the subject identity alert over a target historical period (e.g., past 3 days, past 7 days, past 30 days, etc.).

Accordingly, in such an embodiment of the second implementation, S220 may function to extract, derive, or generate an internet protocol address user prevalence feature based in part on the subject identity alert and/or the historical authentication data retrieved from the third-party identity service. For instance, in a non-limiting example, the digital user may have successfully authenticated from the internet protocol address specified in the subject identity alert four times within the past thirty (30) days and successfully authenticated from other internet protocol addresses once (1), resulting in a total of five successful authentications during the target historical period. In such an example, S220 may compute that the internet protocol address user prevalence feature corresponds to 0.8 (or 80%), representing the frequency of successful authentications from the internet protocol address specified in the subject identity alert relative to the total number of successful authentications by the digital user over the target historical period.

It shall be recognized that the internet protocol address user prevalence feature may serve as an indicator of whether the subject identity alert is associated with potentially malicious or non-malicious activity. In particular, a higher IP address user prevalence feature value (e.g., .8, .9, 1) may indicate that the IP address specified in the subject identity alert is commonly or repeatedly used by the digital user for successful authentications within the target computing environment, thereby suggesting familiar, legitimate, and non-malicious behavior. Conversely, a lower IP address user prevalence feature value (e.g., .1, .2, .3, .4) or a first-time occurrence of authentication from a new or previously unseen IP address may indicate that the observed access attempt is atypical for the digital user and therefore potentially indicative of malicious or anomalous activity, such as an unauthorized login attempt or compromised credentials.

### Internet Protocol Address Environment Prevalence Feature

Additionally, or alternatively, in one or more embodiments, in response to obtaining the subject identity alert, S220 may function to automatically compute, for the subject identity alert, an internet protocol address environment prevalence feature value for the subject identity alert. In one or more embodiments, the internet protocol address environment prevalence feature value computed for the subject identity alert may also be referred to herein as the feature value for the internet protocol address environment prevalence feature.

In one or more embodiments, in response to obtaining the subject identity alert, S220 may function to compute, determine, and/or extract, in real-time or near real-time, a feature value corresponding to the internet protocol address environment prevalence feature for the subject identity alert. In one or more embodiments, S220 may function to automatically compute, for a predetermined time span (e.g., last 60 days, last 30 days, last 15 days, etc.), a total number of unique users that have successfully authenticated or logged in to the target computing environment specified in the subject identity alert. Stated another way, in one or more embodiments, S220 may function to compute, in real-time or near real-time, an aggregate count representing the total number of distinct digital users that, during the predetermined time span, successfully authenticated to the target computing environment from the internet protocol address specified in the subject identity alert. In other words, in some embodiments, S220 may function to compute, in real-time or near real-time, a numerical value indicating how many unique digital users, within the predetermined time span, generated, caused, and/or contributed to at least one successful authentication event to the target computing environment from the internet protocol address specified in the subject identity alert.

For instance, in a non-limiting example, the feature value of the internet protocol address environment prevalence feature computed for the subject identity alert may be a numerical value of one (1) when only a single digital user successfully authenticated to the target computing environment from the internet protocol address specified in the subject identity alert during the predetermined time span. In another non-limiting example, the feature value of the internet protocol address environment prevalence feature computed for the subject identity alert may be a numerical value of twenty (20) based on detecting that twenty distinct digital users have successfully authenticated to the target computing environment from the internet protocol address specified in the subject identity alert during the predetermined time span.

It shall be recognized that, in such a non-limiting example, S220 may function to query one or more authentication logs, identity-management systems, or access-control databases and/or the like to determine, detect, and/or compute the total number of distinct digital users that have successfully logged in to the target computing environment during the predetermined time span.

### Internet Protocol Address Organization Prevalence Feature

Additionally, or alternatively, in one or more embodiments, in response to obtaining the subject identity alert, S220 may function to automatically compute, for the subject identity alert, an internet protocol address organization prevalence feature value for the subject identity alert. In one or more embodiments, the internet protocol address organization prevalence feature value computed for the subject identity alert may also be referred to herein as the feature value for the internet protocol address organization prevalence feature.

In one or more embodiments, in response to obtaining the subject identity alert, S220 may function to compute, determine, and/or extract, in real-time or near real-time, a feature value corresponding to the internet protocol address organization prevalence feature for the subject identity alert. In one or more embodiments, S220 may function to identify, using an internet protocol (IP) enrichment service or the like, an organization corresponding to the internet protocol address specified in the subject identity alert and, in turn, compute, determine, and/or detect a total number of times the digital user involved in the subject identity alert has successfully authenticated to the target computing environment from internet protocol addresses attributed to that same organization during the predetermined time span. Stated another way, in one or more embodiments, S220 may function to compute, in real-time or near real-time, a cumulative count of successful authentication-event records linked to the digital user in which the originating internet protocol address was mapped, via the IP enrichment service, to the organization (e.g., palo alto networks, inc.) associated with the internet protocol address specified in the subject identity alert. An organization, in some embodiments, may correspond to an entity identified by the IP enrichment service as the registered owner, operator, or autonomous system associated with the internet protocol address, including but not limited to internet service providers, enterprise network operators, cloud service providers, hosting providers, mobile carriers, or other network infrastructure organizations.

For instance, in a non-limiting example, the feature value of the internet protocol address organization prevalence feature computed for the subject identity alert may be a numerical value of one (1) when the authentication-event data records indicate that, within the predetermined time span, the digital user generated only a single successful authentication event (e.g., logged in to the target computing environment or the like) from an internet protocol address whose ownership or registration is attributed to the organization identified in the subject identity alert. In another non-limiting example, the feature value of the internet protocol address organization prevalence feature computed for the subject identity alert may be a numerical value of sixteen (16) when the system or service implementing method 200 detects that, within the predetermined time span, the digital user generated sixteen successful authentication events (e.g., logged in to the target computing environment sixteen times) from an internet protocol address whose ownership or registration is attributed to the organization (e.g., IP organization) derived from the subject identity alert.

It shall be recognized that, in such a non-limiting example, S220 may function to query one or more authentication logs, identity-management systems, or access-control databases and/or the like to determine, detect, and/or compute the feature value of the internet protocol address organization prevalence feature.

### Autonomous System Number ASN Prevalence Feature

Additionally, or alternatively, in one or more embodiments, in response to obtaining the subject identity alert, S220 may function to automatically compute, for the subject identity alert, an ASN prevalence feature value for the subject identity alert. In one or more embodiments, the ASN prevalence feature value computed for the subject identity alert may also be referred to herein as the feature value for the ASN prevalence feature.

In one or more embodiments, S220 may function to compute, determine, and/or extract, in real-time or near real-time, a feature value corresponding to the ASN prevalence feature for the subject identity alert. In such an embodiment, S220 may function to identity, using an internal or external service of the identity threat detection and response service, an autonomous system number corresponding to the internet protocol address specified in the subject identity alert and, in turn, compute, determine, or detect a total number of times the digital user has used the autonomous system number as the originating autonomous system for successful authentication events during the predetermined time span. Stated another way, in one or more embodiments, S220 may function to compute, in real-time or near real-time, a total count of successful authentication event data records digitally linked to the digital user in which the respective internet protocol address in each authentication event data records was mapped to the same autonomous system number (ASN) associated with the internet protocol address specified in the subject identity alert. It shall be recognized that, in some embodiments, an ASN may correspond to a network operator, internet service provider, mobile carrier, cloud provider, hosting provider, enterprise network, or other autonomous system owner responsible for routing traffic for an associated range of internet protocol addresses.

For instance, in a non-limiting example, the feature value of the ASN prevalence feature computed for the subject identity alert may be a numerical value of one (1) when the system or service implementing method 200 determines that, within the predetermined time span, the digital user generated only a single successful authentication event from an internet protocol address attributed to the same ASN as the internet protocol address specified in the subject identity alert. In another non-limiting example, the feature value of the ASN prevalence feature computed for the subject identity alert may be a numerical value of ten (10) when the system or service implementing method 200 determines that, within the predetermined time span, the digital user initiated ten successful authentication events from internet protocol addresses corresponding to the same autonomous system number (ASN) identified for the internet protocol address involved in the subject identity alert.

It shall be recognized that, in such a non-limiting example, S220 may function to query one or more authentication logs, identity-management systems, or access-control databases and/or the like to determine, detect, and/or compute the feature value of the ASN prevalence feature.

### Geographical Region Prevalence Feature

Additionally, or alternatively, in one or more embodiments, in response to obtaining the subject identity alert, S220 may function to automatically compute, for the subject identity alert, a geographical region prevalence feature value for the subject identity alert. In one or more embodiments, the geographical region prevalence feature value computed for the subject identity alert may also be referred to herein as the feature value for the geographical region prevalence feature.

In one or more embodiments, S220 may function to compute, determine, and/or extract, in real-time or near real-time, a feature value corresponding to the geographical region prevalence feature for the subject identity alert. In such embodiments, S220 may function to automatically determine a geographical region (e.g., city, state, country, continent, etc.) corresponding to the internet protocol address specified in the subject identity alert and, in turn, compute, determine, and/or detect a total number of times the digital user involved in the subject identity alert has successfully authenticated to the target computing environment from the geographical region during the predetermined time span. Stated another way, in some embodiments, S220 may function to determine a total number of times the digital user has successfully logged onto the target computing environment from the geographical region during the predetermined time span.

For instance, in a non-limiting example, the feature value of the geographical region prevalence feature computed for the subject identity alert may be a numerical value of zero (0) when the system or service implementing method 200 determines that, within the predetermined time span, the digital user did not successfully log in to the target computing environment from the geographical region. In another non-limiting example, the feature value of the geographical region prevalence feature computed for the subject identity alert may be a numerical value of one (1) when the system or service implementing method 200 determines that, within the predetermined time span, the digital user successfully logged in once to the target computing environment from the geographical region. In another non-limiting example, the feature value of the geographical region prevalence feature computed for the subject identity alert may be a numerical value of ten (10) when the system or service implementing method 200 determines that, within the predetermined time span, the digital user successfully logged in ten times to the target computing environment from the geographical region.

It shall be recognized that, in such a non-limiting example, S220 may function to query logs, databases, and/or the like to determine, detect, and/or compute the feature value of the geographical region prevalence feature.

### Virtual Private Network VPN User Prevalence Feature

Additionally, or alternatively, in one or more embodiments, in response to obtaining the subject identity alert, S220 may function to automatically compute, for the subject identity alert, a virtual private network (VPN) user prevalence feature value for the subject identity alert. In one or more embodiments, the VPN user prevalence feature value computed for the subject identity alert may also be referred to herein as the feature value for the VPN user prevalence feature.

In one or more embodiments, S220 may function to compute, determine, and/or extract, in real-time or near real-time, a feature value corresponding to the VPN user prevalence feature for the subject identity alert. In such embodiments, S220 may function to automatically determine whether the digital user involved in the subject identity alert used a VPN to log in to the target computing environment. Accordingly, in one or more embodiments, in response to detecting the digital user used the VPN to log in to the target computing environment, S220 may further compute, determine, and/or detect a total number of times the digital user has successfully authenticated to the target computing environment from the VPN during the predetermined time span. Stated another way, in some embodiments, S220 may function to compute a numerical value representing the cumulative count of successful authentication events attributable to the digital user that originated from the VPN used or involved in the subject identity alert.

For instance, in a non-limiting example, the feature value of the VPN user prevalence feature computed for the subject identity alert may be zero (0) when the system or service implementing method 200 determines that, within the predetermined time span, the digital user has not historically logged in to the target computing environment from the same VPN used (or involved) in the subject identity alert. In another non-limiting example, the feature value of the VPN user prevalence feature may be a numerical value of one (1) when the system or service implementing method 200 determines that, within the predetermined time span, the digital user has historically logged in once to the target computing environment from the same VPN. In yet another non-limiting example, the feature value of the VPN user prevalence feature may be a numerical value of ten (10) when the system or service implementing method 200 determines that, within the predetermined time span, the digital user has historically logged in ten times to the target computing environment from the same VPN used (or involved) in the subject identity alert.

It shall be recognized that, in one or more embodiments, the VPN may refer to a commercial VPN provider (e.g., a public VPN exit node), an enterprise remote-access VPN gateway used by employees to access internal resources, a cloud-hosted VPN node operated by a cloud service provider, or a device-level VPN connection established on a mobile or desktop device, or any other suitable VPN endpoint, provider, node, or network path through which the digital user accessed or attempted to access the target computing environment.

It shall be recognized that, in such a non-limiting example, S220 may function to query logs, databases, and/or the like to determine, detect, and/or compute the feature value of the VPN user prevalence feature.

### Virtual Private Network VPN Environment Prevalence Feature

Additionally, or alternatively, in one or more embodiments, in response to obtaining the subject identity alert, S220 may function to automatically compute, for the subject identity alert, a virtual private network (VPN) environment prevalence feature value for the subject identity alert. In one or more embodiments, the VPN environment prevalence feature value computed for the subject identity alert may also be referred to herein as the feature value for the VPN environment prevalence feature.

In one or more embodiments, in response to obtaining the subject identity alert, S220 may function to compute, determine, and/or extract, in real-time or near real-time, a feature value corresponding to the VPN environment prevalence feature for the subject identity alert. In such embodiments, S220 may function to automatically determine, in real-time or near real-time, a total number of unique digital users that have successfully authenticated or logged in to the target computing environment from the same VPN used (or involved) in the subject identity alert during a predetermined time span (e.g., last 60 days, last 30 days, last 15 days, etc.). Stated another way, in some embodiments, S220 may function to compute, in real-time or near real-time, an aggregate count representing a total number of distinct digital users that, within the predetermined time span, generated, caused, and/or contributed to at least one successful authentication event to the target computing environment from the VPN identified in the subject identity alert.

For instance, in a non-limiting example, the feature value of the VPN environment prevalence feature computed for the subject identity alert may be a numerical value of one (1) when only a single digital user has successfully authenticated to the target computing environment from the same VPN used in the subject identity alert during the predetermined time span. In another non-limiting example, the feature value of the VPN environment prevalence feature computed for the subject identity alert may be a numerical value of twenty (20) based on detecting that twenty distinct digital users have successfully authenticated to the target computing environment from the same VPN used in the subject identity alert during the predetermined time span.

It shall be recognized that, in such a non-limiting example, S220 may function to query one or more authentication logs, identity-management systems, access-control databases, VPN-detection engines, IP-enrichment services, and/or the like to determine, detect, and/or compute the feature value of the VPN environment prevalence feature.

### Hosting User Prevalence Feature

Additionally, or alternatively, in one or more embodiments, in response to obtaining the subject identity alert, S220 may function to automatically compute, for the subject identity alert, a hosting user prevalence feature value for the subject identity alert. In one or more embodiments, the hosting user prevalence feature value computed for the subject identity alert may also be referred to herein as the feature value for the hosting user prevalence feature.

In one or more embodiments, in response to obtaining the subject identity alert, S220 may function to compute, determine, and/or extract, in real time or near real time, a feature value corresponding to the hosting user prevalence feature for the subject identity alert. In such embodiments, S220 may function to automatically determine whether the internet protocol address specified in the subject identity alert is associated with a host identifier (also referred to herein as a host ID). As used herein, a host ID may correspond to a unique identifier representing a particular remote computing system or network origin, such as a server, virtual machine, remote workstation, cloud instance, or other remotely accessible system, from which authentication events to the target computing environment may originate.

Accordingly, in one or more embodiments, in response to determining that the digital user involved in the subject identity alert authenticated to the target computing environment from a host identified by the host ID, S220 may further function to compute, determine, and/or detect a total number of times the digital user has historically authenticated to the target computing environment from the same host ID during a predetermined time span (e.g., last 60 days, last 30 days, last 15 days, etc.). Stated another way, S220 may function to compute, in real time or near real time, a numerical value representing the cumulative count of successful authentication events of the digital user that are mapped to the same host ID identified in the subject identity alert.

For instance, in a non-limiting example, the feature value of the hosting user prevalence feature computed for the subject identity alert may be zero (0) when the system or service implementing method 200 determines that, within the predetermined time span, the digital user has not previously authenticated to the target computing environment from a host corresponding to the host ID identified in the subject identity alert. In another non-limiting example, the feature value of the hosting user prevalence feature may be one (1) when the system or service implementing method 200 determines that, within the predetermined time span, the digital user has authenticated once from the same host ID. In yet another non-limiting example, the feature value of the hosting user prevalence feature may be ten (10) when the system or service implementing method 200 determines that, within the predetermined time span, the digital user has authenticated ten times from a host corresponding to the host ID identified in the subject identity alert.

It shall be recognized that the hosting user prevalence feature may serve as an indicator of whether the subject identity alert is associated with potentially malicious or non-malicious activity. A higher hosting user prevalence value may indicate routine or expected authentication behavior by the digital user from the same host ID, thereby suggesting familiar and legitimate usage patterns. Conversely, a lower or zero hosting user prevalence value may indicate that the host ID associated with the subject identity alert is new, uncommon, or otherwise atypical for the digital user, which may in turn signify anomalous or potentially malicious activity—such as the use of an unfamiliar remote computing system to attempt authentication.

It shall be further recognized that, in one or more embodiments, S220 may function to query authentication logs, identity-management systems, access-control databases, host services, or any combination thereof, to determine, detect, and/or compute the feature value of the hosting user prevalence feature.

### Deletion Event Feature

Additionally, or alternatively, in one or more embodiments, in response to obtaining the subject identity alert, S220 may function to automatically compute, for the subject identity alert, a deletion event feature value for the subject identity alert. In one or more embodiments, the deletion event feature value computed for the subject identity alert may also be referred to herein as the feature value for the deletion event feature.

In one or more embodiments, in response to obtaining the subject identity alert, S220 may function to compute, determine, and/or extract, in real time or near real time, a feature value corresponding to the deletion event feature for the subject identity alert. In such embodiments, S220 may function to automatically identify and aggregate one or more deletion-related user actions that occurred within a predetermined time span (e.g., last 60 days, last 30 days, last 7 days, etc.) and that are attributable to the digital user involved in the subject identity alert. Stated another way, S220 may function to determine, in real time or near real time, an aggregate count of deletion events associated with the digital user that occurred prior to, or proximate in time to, the subject identity alert.

As used herein, a “deletion event” may correspond to any action in which the digital user removes, destroys, or otherwise eliminates data, artifacts, or records within the target computing environment. For example, deletion events may include, but are not limited to, deleting emails from an inbox or folder; removing files or documents from shared repositories; clearing audit logs or activity histories; deleting authentication tokens or device registrations; removing application data; or issuing administrative commands that purge system records. In one or more embodiments, S220 may function to quantify these deletion events to compute a numerical value representing the total number of deletion actions performed by the digital user during the predetermined time span.

For instance, in a non-limiting example, the feature value of the deletion event feature may be a numerical value of zero (0) when no deletion events attributable to the digital user are detected within the predetermined time span (for example, the past thirty (30) days from the time the subject identity alert was received, obtained or generated). In another non-limiting example, the feature value may be one (1) when a single deletion event, such as the deletion of an email, is detected within the thirty-day period. In yet another non-limiting example, the feature value of the deletion event feature may be twenty (20) when the system or service implementing method 200 identifies twenty deletion events, such as deletion of multiple emails, removal of files, or clearing of logs, performed by the digital user during the past thirty (30) days preceding receipt of the subject identity alert.

It shall be recognized that the deletion event feature may serve as an indicator of whether the subject identity alert is associated with potentially malicious or non-malicious activity. In particular, a higher deletion event feature value, such as ten (10) or more deletion events within the predetermined time span, may indicate abnormal or suspicious behavior by the digital user. Such elevated activity may suggest attempts to remove evidence of unauthorized access, obscure prior actions, or otherwise reduce auditability within the target computing environment. Conversely, a lower deletion event feature value, including a value of zero (0) or one (1), may indicate routine or expected behavior in which the digital user performs minimal data removal, thereby reducing the likelihood that the observed activity is malicious. In one or more embodiments, S220 may function to query and assess one or more authentication logs, activity logs, email systems, file repositories, administrative consoles, or other relevant data sources to determine, detect, and/or compute the feature value of the deletion event feature.

Stated another way, in one or more embodiments, an identity alert is associated with a digital user and, in turn, the system or service implementing method 200 may function to (i) identify, based on assessing log data, one or more deletion events attributable to the digital user that occurred during a historical time span, wherein each deletion event of the one or more deletion events corresponds to a distinct action by the digital user that removes, destroys, or eliminates data within a computing environment of the subscribing entity and (ii) determine, based on the one or more deletion events, a total number of deletion events attributable to the digital user during the historical time span. Accordingly, in such an embodiment, the identity alert feature vector generated for the identity alert may include a feature value for a subject feature, wherein the feature value for the subject feature specifies the total number of deletion events attributable to the digital user during the historical time span.

### Consecutive Multi-factor Authentication MFA Failure Feature

Additionally, or alternatively, in one or more embodiments, in response to obtaining the subject identity alert, S220 may function to automatically compute, for the subject identity alert, a consecutive multi-factor authentication (MFA) failure feature value for the subject identity alert. In one or more embodiments, the consecutive MFA failure feature value computed for the subject identity alert may also be referred to herein as the feature value for the consecutive MFA failure feature.

In one or more embodiments, S220 may function to compute, determine, and/or extract, in real time or near real time, a feature value corresponding to the consecutive MFA failure feature for the subject identity alert. In such embodiments, S220 may function to analyze MFA challenge records attributable to the digital user during the past thirty (30) days and identify all sequences in which the digital user generated two or more consecutive MFA failures. S220 may then compute a numerical value representing the total number of such consecutive MFA failure sequences detected within that thirty-day period. Stated another way, in one or more embodiments, S220 may function to determine, in real time or near real time, how many distinct consecutive MFA failure instances occurred during the past thirty (30) days in which the digital user produced at least back-to-back MFA failures, with each distinct consecutive MFA failure instance consisting of at least two failed MFA attempts occurring consecutively without an intervening successful authentication. Each such distinct consecutive MFA failure instance may be counted as a single consecutive MFA failure sequence, and the resulting feature value may correspond to the total number of these consecutive MFA failure sequences identified for the digital user within the predetermined time span.

Non-limiting examples of a consecutive MFA failure sequence may include instances in which the digital user generates two or more MFA failures back-to-back without an intervening successful MFA challenge. For example, a first consecutive MFA failure sequence may occur when the digital user fails an MFA challenge twice in succession (e.g., “fail, fail” followed by a later successful authentication). In another non-limiting example, a consecutive MFA failure sequence may consist of three consecutive MFA failures (e.g., “fail, fail, fail”) before the digital user eventually completes a successful MFA challenge. In yet another non-limiting example, a consecutive MFA failure sequence may occur even when no successful MFA challenge follows the failures. For instance, if the digital user generates ten consecutive MFA failures (e.g., “fail, fail, fail, fail, fail, fail, fail, fail, fail, fail”) with no successful MFA attempt during that period, the system or service implementing method 200 may treat the entire series of ten failures as a single consecutive MFA failure sequence.

For instance, in a non-limiting example, the feature value of the consecutive MFA failure feature may be zero (0) when the system or service implementing method 200 determines that, within the past thirty (30) days, no consecutive MFA failure sequences attributable to the digital user occurred. In another non-limiting example, the feature value may be one (1) when the digital user generated or caused a single consecutive MFA failure sequence, such as two back-to-back MFA failures. In yet another non-limiting example, the feature value of the consecutive MFA failure feature may be five (5) when the system or service implementing method 200 identifies five distinct consecutive MFA failure sequences attributable to the digital user during the past thirty (30) days, with each sequence consisting of at least two MFA failures occurring consecutively without an intervening successful authentication.

It shall be recognized that the consecutive MFA failure feature may serve as an indicator of whether the subject identity alert is associated with potentially malicious or non-malicious activity. In particular, a higher consecutive MFA failure feature value, such as five (5) or more consecutive MFA failure sequences within the past thirty (30) days, may indicate abnormal or suspicious authentication behavior attributable to the digital user. Such elevated activity may suggest repeated unauthorized access attempts, credential misuse, or automated attempts to bypass MFA protections. Conversely, a lower consecutive MFA failure feature value, including a value of zero (0) or one (1), may indicate routine or expected authentication behavior in which MFA failures are infrequent and unlikely to reflect malicious intent. In one or more embodiments, S220 may function to automatically query and assess MFA logs, authentication systems, identity-management platforms, or other relevant data sources to determine, detect, and compute the feature value of the consecutive MFA failure feature for the subject identity alert.

### Malicious Attribute Feature

Additionally, or alternatively, in one or more embodiments, in response to obtaining the subject identity alert, S220 may function to automatically compute, for the subject identity alert, a malicious attribute feature value for the subject identity alert. In one or more embodiments, the malicious attribute feature value computed for the subject identity alert may also be referred to herein as the feature value for the malicious attribute feature.

In one or more embodiments, S220 may function to compute, determine, and/or extract, in real time or near real time, a feature value corresponding to the malicious attribute feature for the subject identity alert. In such embodiments, S220 may function to automatically evaluate one or more pieces of alert data included in and/or associated with the subject identity alert, including but not limited to an internet protocol address value, an autonomous system number (ASN), an organization identifier, a domain name, a host identifier, a VPN endpoint, or any other attribute derived from the alert data of the subject identity alert and, in turn, S220 may function to automatically detect whether any of the one or more pieces of alert data appear in, match, or otherwise correspond to one or more known malicious attribute datasets maintained by the identity threat detection and response service.

In one or more embodiments, a malicious attribute dataset may include a corpus of indicators, entities, or attributes that have been previously associated with suspicious, harmful, or otherwise malicious activity. Such malicious attribute datasets may include, but are not limited to, lists of malicious internet protocol addresses, malicious autonomous system numbers (ASNs), malicious organizations, malicious or high-risk domains, known threat-actor infrastructure, compromised hosts, VPN exit nodes historically linked to abuse, or any other attribute classified as malicious by security analysts or external threat-intelligence sources.

Accordingly, in one or more embodiments, in response to determining (e.g., detecting or the like) that at least one piece of metadata (e.g., one piece of alert data) associated with the subject identity alert appears in, or matches, a malicious attribute dataset, S220 may function to compute a numerical value representing the malicious attribute feature for the subject identity alert. In one non-limiting example, the malicious attribute feature value may be zero (0) when none of the metadata attributes associated with or included in the subject identity alert correspond to any malicious attribute included in the plurality of malicious attribute datasets controlled by the identity threat detection and response service. In another non-limiting example, the malicious attribute feature value may be one (1) when the system or service implementing method 200 determines that at least one metadata attribute associated with the subject identity alert corresponds to, or is otherwise found within, one or more malicious attribute datasets maintained by the identity threat detection and response service. Stated another way, the malicious attribute feature is a binary indicator that is set to zero (0) when no malicious attribute match is detected and set to one (1) when any such malicious attribute match is detected.

It shall be recognized that the malicious attribute feature may serve as an indicator of whether the subject identity alert is associated with, or contains, a known malicious attribute included in one or more malicious attribute datasets. A malicious attribute feature value of one (1) may indicate that at least one metadata attribute of the subject identity alert appears in, or matches, a malicious attribute included in such a dataset, whereas a malicious attribute feature value of zero (0) may indicate that none of the metadata attributes associated with the subject identity alert correspond to any malicious attribute included in the plurality malicious attribute datasets maintained by the identity threat detection and response service.

### MFA Device IP Association Feature

Additionally, or alternatively, in one or more embodiments, in response to obtaining the subject identity alert, S220 may function to automatically compute, for the subject identity alert, an MFA device IP association feature value for the subject identity alert. In one or more embodiments, the MFA device IP association feature value computed for the subject identity alert may also be referred to herein as the feature value for the MFA device IP association feature.

In one or more embodiments, S220 may function to compute, determine, and/or extract, in real time or near real time, a feature value corresponding to the MFA device IP association feature for the subject identity alert. In such embodiments, S220 may function to automatically determine whether the internet protocol address specified in the subject identity alert has previously been associated with, or used by, the MFA device linked to the digital user. As used herein, an MFA device may correspond to any device, token, authenticator application, hardware key, or other mechanism registered or recognized as part of the digital user's multi-factor authentication profile.

In one or more embodiments, S220 may function to analyze historical authentication data, MFA challenge records, device registration metadata, or any other relevant source of MFA-related activity to detect whether the MFA device associated with the digital user has been observed authenticating from the same internet protocol address within a predetermined time span (for example, the past thirty (30) days). Stated another way, S220 may function to determine whether the MFA device tied to the digital user has a historical or established association with the internet protocol address specified in the subject identity alert.

For instance, in a non-limiting example, the MFA device IP association feature value may be zero (0) when the system or service implementing method 200 determines that the MFA device linked to the digital user has not historically been observed authenticating from, or otherwise communicating through, the internet protocol address specified in the subject identity alert during the predetermined time span. In another non-limiting example, the feature value may be one (1) when the system determines that the MFA device tied to the digital user has previously authenticated from the same internet protocol address during the predetermined time span (e.g., 30 days prior to a time the subject identity alert was obtained, received, or generated).

It shall be recognized that the MFA device IP association feature may serve as an indicator of whether the subject identity alert reflects expected or unexpected MFA-related behavior. In particular, a feature value of one (1) may indicate that the internet protocol address is consistent with known or routine usage patterns of the MFA device, thereby reducing the likelihood that the observed authentication activity is malicious. Conversely, a feature value of zero (0) may indicate that the internet protocol address is new, unusual, or otherwise not associated with the MFA device, which may suggest anomalous or potentially unauthorized activity such as device compromise, credential misuse, or adversary-in-the-middle activity.

In one or more embodiments, S220 may function to query authentication logs, MFA service logs, device registration systems, identity-management platforms, or any combination thereof to determine, detect, and/or compute the feature value of the MFA device IP association feature.

It shall be further recognized that, in some embodiments, the MFA device IP association feature may correspond to a Boolean-type feature that indicates, in a binary manner, whether the MFA device associated with the digital user has been previously observed authenticating from the internet protocol address specified in the subject identity alert. Stated another way, the feature value may be set to zero (0) when no such prior association exists and set to one (1) when the MFA device has historically authenticated from the same internet protocol address within the predetermined time span (e.g., 30 days prior to a time the subject identity alert was obtained, received, or generated by the system or service implementing method 200).

### Valid MFA Device Feature

Additionally, or alternatively, in one or more embodiments, in response to obtaining the subject identity alert, S220 may function to automatically compute, for the subject identity alert, a valid MFA device feature value for the subject identity alert. In one or more embodiments, the valid MFA device feature value computed for the subject identity alert may also be referred to herein as the feature value for the valid MFA device feature.

In one or more embodiments, S220 may function to compute, determine, and extract, in real time or near real time, a feature value corresponding to the valid MFA device feature for the subject identity alert. In such embodiments, S220 may function to automatically determine whether at least one valid MFA device associated with the digital user has previously authenticated to the target computing environment from the same internet protocol address specified in the subject identity alert. A valid MFA device, as used herein, may correspond to any registered, approved, or otherwise recognized multi-factor authentication device assigned to the digital user by the subscribing entity, including but not limited to mobile authenticator applications, hardware tokens, push-notification devices, or other MFA mechanisms enrolled for the digital user.

Accordingly, in one or more embodiments, S220 may function to compute a numerical value representing whether any valid MFA device associated with the digital user has historically authenticated from the internet protocol address specified in the subject identity alert. In one non-limiting example, the valid MFA device feature value may be zero (0) when the system or service implementing method 200 determines that none of the digital user's valid MFA devices have authenticated from the internet protocol address during a predetermined time span, such as the past thirty days prior to a time the subject identity alert was obtained, received, or generated by the system or service implementing method 200. In another non-limiting example, the valid MFA device feature value may be one (1) when the system or service implementing method 200 determines that at least one valid MFA device associated with the digital user has authenticated from the internet protocol address within the predetermined time span, such as the past thirty days prior to a time the subject identity alert was obtained, received, or generated by the system or service implementing method 200.

Stated another way, the valid MFA device feature may correspond to a binary indicator that is set to zero (0) when no valid MFA device associated with the digital user has authenticated from the internet protocol address specified in the subject identity alert, and set to one (1) when at least one such valid MFA device has authenticated from that internet protocol address.

It shall be recognized that the valid MFA device feature may serve as an indicator of whether the subject identity alert is associated with potentially legitimate or illegitimate authentication behavior. A valid MFA device feature value of one (1) may suggest expected or familiar behavior by the digital user, while a value of zero (0) may indicate that the internet protocol address has not historically been used by any valid MFA device associated with the user, thereby increasing the likelihood that the observed activity is anomalous or potentially malicious.

Additionally, or alternatively, in one or more embodiments, S220 may function to compute, determine, and extract, in real time or near real time, a feature value corresponding to the MFA device association feature for the subject identity alert. In such embodiments, S220 may function to automatically determine whether the internet protocol address specified in the subject identity alert has previously been associated with any MFA-capable device. As used herein, an MFA-capable device may correspond to any device or endpoint that has generated or responded to a multi-factor authentication challenge, including authenticator applications, push-notification devices, hardware tokens, or any device that has participated in an MFA flow. Accordingly, in one or more embodiments, S220 may function to compute a numerical value representing whether the internet protocol address specified in the subject identity alert has, at any point within a predetermined time span (for example, the past thirty days from a time the subject identity alert was obtained, received, or generated by the system or service implementing method 200), has been associated with at least one MFA-capable device. In one non-limiting example, the feature value may be zero (0) when the system or service implementing method 200 determines that no MFA-capable device has been associated with the internet protocol address during the predetermined time span (e.g., the last 30 days relative to a time at which the subject identity alert was obtained, received, or generated). In another non-limiting example, the feature value may be one (1) when the system or service implementing method 200 determines that at least one MFA-capable device has been associated with the internet protocol address during the predetermined time span. Stated another way, the MFA device association feature is a binary indicator that is set to zero (0) when the internet protocol address has no historical association with any MFA-capable device and set to one (1) when such an association exists.

It shall be recognized that, in such an embodiment, the MFA device association feature may serve as an indicator of whether the internet protocol address specified in the subject identity alert has been used in MFA flows at all. A feature value of one (1) may indicate that the internet protocol address has been involved in at least one MFA process, which may suggest benign, expected use or established authentication behavior. Conversely, a feature value of zero (0) may indicate that the internet protocol address has not been observed participating in MFA processes, which may increase the likelihood that the observed activity is suspicious or reflective of unauthorized access attempts.

### Strong MFA Device Feature

Additionally, or alternatively, in one or more embodiments, in response to obtaining the subject identity alert, S220 may function to automatically compute, for the subject identity alert, a strong MFA device feature value for the subject identity alert. In one or more embodiments, the strong MFA device feature value computed for the subject identity alert may also be referred to herein as the feature value for the strong MFA device feature.

In one or more embodiments, S220 may function to automatically assess one or more logs associated with the subject identity alert or the subscribing entity to detect the MFA device that the digital user used to log in to the target computing environment. In one or more embodiments, S220 may function to detect the MFA device recorded in the one or more logs and determine whether the detected MFA device corresponds to a strong MFA device. As used herein, a strong MFA device may correspond to any MFA device classified as phishing-resistant, hardware-backed, or otherwise offering elevated assurance of authentication integrity. In one or more embodiments, S220 may function to determine whether the MFA device detected in connection with the subject identity alert matches any identifier included in a predetermined set of strong MFA device identifiers. Such designations may include, for example, identifiers or strings such as “FIDO_WEBAUTHN,” “SIGNED_NONCE,” or any other strong MFA device identifiers defined, curated, or otherwise recognized by the identity threat detection and response service as constituting strong MFA authentication.

In one or more embodiments, in response to determining whether the MFA device used in connection with the subject identity alert corresponds to a strong MFA device, S220 may function to compute a numerical value representing the strong MFA device feature for the subject identity alert. For instance, in a non-limiting example, the system or service implementing method 200 may assess one or more logs associated with the subject identity alert or the subscribing entity and detect that a string (e.g., MFA identifier string or the like) included in the one or more logs is “FIDO_WEBAUTHN.” Because “FIDO_WEBAUTHN” is included in the predetermined set of strong MFA device identifiers, S220 may compute the strong MFA device feature value as one (1). In another non-limiting example, the system or service implementing method 200 may assess the one or more logs associated with the subject identity alert or the subscribing entity and detect that the MFA device string recorded for the authentication event is “SMS_OTP,” which is not included in the predetermined set of strong MFA device identifiers. Accordingly, S220 may compute the strong MFA device feature value as zero (0). Stated another way, the strong MFA device feature may correspond to a binary value that is set to one (1) when the MFA device detected in the one or more logs matches a strong MFA device identifier included in the predetermined set of strong MFA device identifiers, and set to zero (0) when the detected MFA device does not match any identifier included in the predetermined strong MFA device set.

It shall be recognized that the strong MFA device feature may serve as an indicator of whether the authentication event associated with the subject identity alert was performed using a phishing-resistant or otherwise high-assurance MFA mechanism. A feature value of one (1) may indicate increased authentication integrity, whereas a value of zero (0) may indicate that the authentication event used an MFA device with lower assurance characteristics, thereby potentially elevating the risk associated with the subject identity alert.

### Weak MFA Device Feature

Additionally, or alternatively, in one or more embodiments, in response to obtaining the subject identity alert, S220 may function to automatically compute, for the subject identity alert, a weak MFA device feature value for the subject identity alert. In one or more embodiments, the weak MFA device feature value computed for the subject identity alert may also be referred to herein as the feature value for the weak MFA device feature.

In one or more embodiments, S220 may function to automatically assess one or more logs associated with the subject identity alert or the subscribing entity to detect the MFA device that the digital user used to log in to the target computing environment. In such embodiments, S220 may function to detect the MFA device recorded in the one or more logs and determine whether the detected MFA device corresponds to a weak MFA device. As used herein, a weak MFA device may correspond to any MFA mechanism that is not phishing-resistant, is software-based without hardware binding, or is otherwise considered lower assurance. Examples of weak MFA devices, in some embodiments, may include SMS-based one-time passwords (SMS OTP), email-delivered one-time codes, time-based one-time password (TOTP) applications, phone-call MFA, or other MFA mechanisms that do not meet the criteria for strong MFA authentication.

In one or more embodiments, S220 may function to determine whether the MFA device detected in connection with the subject identity alert matches any identifier included in a predetermined set of weak MFA device identifiers. Such designations may include, for example, identifiers or strings such as "SMS_OTP," "EMAIL_OTP," "TOTP," "VOICE_CALL," or any other weak MFA device identifiers defined, curated, or otherwise recognized by the identity threat detection and response service as constituting weak MFA authentication.

In one or more embodiments, in response to determining whether the MFA device used in connection with the subject identity alert corresponds to a weak MFA device, S220 may function to compute a numerical value representing the weak MFA device feature for the subject identity alert. For instance, in a non-limiting example, the system or service implementing method 200 may assess one or more logs associated with the subject identity alert or the subscribing entity and detect that a string (e.g., MFA identifier string or the like) included in the one or more logs is "SMS_OTP." Because "SMS_OTP" is included in the predetermined set of weak MFA device identifiers, S220 may compute the weak MFA device feature value as one (1). In another non-limiting example, the system or service implementing method 200 may assess the one or more logs associated with the subject identity alert and detect that the MFA device string recorded for the authentication event is "FIDO_WEBAUTHN," which is not included in the predetermined set of weak MFA identifiers. Accordingly, S220 may compute the weak MFA device feature value as zero (0). Stated another way, the weak MFA device feature may correspond to a binary value that is set to one (1) when the MFA device detected in the one or more logs matches a weak MFA device identifier included in the predetermined weak MFA device set, and set to zero (0) when the detected MFA device does not match any identifier included in the predetermined weak MFA device set.

It shall be recognized that the weak MFA device feature may serve as an indicator of whether the authentication event associated with the subject identity alert relied on a potentially lower-assurance authentication mechanism. A feature value of one (1) may indicate that the authentication event used an MFA mechanism (e.g., MFA device) that is more susceptible to phishing, interception, SIM-swapping, or other compromise vectors, thereby potentially elevating the risk associated with the subject identity alert. Conversely, a feature value of zero (0) may indicate that the authentication event did not use a weak MFA device, which may reduce the likelihood that the authentication attempt is malicious or reflects unauthorized access behavior.

### User Agent Feature

Additionally, or alternatively, in one or more embodiments, in response to obtaining the subject identity alert, S220 may function to automatically compute, for the subject identity alert, a user agent feature value for the subject identity alert. In one or more embodiments, the user agent feature value computed for the subject identity alert may also be referred to herein as the feature value for the user agent feature.

In one or more embodiments, S220 may function to compute, determine, and/or extract, in real time or near real time, a feature value corresponding to the user agent feature for the subject identity alert. In such embodiments, S220 may function to automatically assess one or more logs associated with the subject identity alert or the subscribing entity to detect the user agent string that the digital user used when attempting to authenticate to the target computing environment. A “user agent”, in some embodiments, may correspond to metadata provided by the client software, device, or application initiating a network request and may identify, describe, or otherwise characterize the software, platform, or execution environment involved in generating the network request. Non-limiting examples of user agents may include browser-based user agents (e.g., identifiers associated with Chrome, Firefox, or Safari), mobile application user agents (e.g., iOS or Android app identifiers), script- or automation-based user agents (e.g., “python-requests,” “curl/7.x”), or headless or automated browser frameworks (e.g., “HeadlessChrome,” “Selenium/”).

In one or more embodiments, the system or service implementing method 200 may determine whether a user agent string included in or associated with the subject identity alert corresponds to a suspicious user agent included in a predetermined set of suspicious user agents defined by the system or service implementing method 200 and, in response, S220 may function to compute a numerical value representing the user agent feature for the subject identity alert.

In a non-limiting example, the system or service implementing method 200 may assess one or more logs associated with the subject identity alert or the subscribing entity and detect that the user agent string recorded for the authentication attempt is “curl/7.86.” Because “curl/” is included in the predetermined set of suspicious user agent identifiers, S220 may compute the user agent feature value as one (1). In another non-limiting example, S220 may determine that the user agent string recorded for the authentication attempt corresponds to a standard browser identifier, such as a Chrome, Firefox, or Safari user agent string, none of which appear in the predetermined set of suspicious user agents, and, in turn, S220 may compute the user agent feature value as zero (0). Stated another way, the user agent feature may correspond to a binary indicator that is set to one (1) when the user agent string included in or associated with the subject identity alert matches a suspicious user agent included in the predetermined suspicious user agent set, and set to zero (0) when the user agent string included in or associated with the subject identity alert does not match any user agent designated as suspicious.

It shall be recognized that the user agent feature may serve as an indicator of whether the authentication event associated with the subject identity alert was performed using atypical, automated, or potentially malicious software or tooling. A user agent feature value of one (1) may indicate elevated risk or potentially malicious activity, whereas a user agent feature value of zero (0) may indicate that the user agent reflects expected or benign usage patterns.

### User Travel Details Feature

Additionally, or alternatively, in one or more embodiments, in response to obtaining the subject identity alert, S220 may function to automatically compute, for the subject identity alert, a user travel details feature value for the subject identity alert. In one or more embodiments, the user travel details feature value computed for the subject identity alert may also be referred to herein as the feature value for the user travel details feature.

In one or more embodiments, S220 may function to compute, determine, and/or extract, in real time or near real time, a feature value corresponding to the user travel details feature for the subject identity alert. In such embodiments, S220 may function to automatically assess one or more logs or data records associated with the digital user to detect whether any travel-related indicators are present in the one or more logs to determine whether the digital user had documented, reported, or otherwise signaled expected travel prior to, or proximate in time to, the subject identity alert. In one or more embodiments, S220 may function to search for travel-related textual indicators included in logs, messages, notes, calendar entries (e.g., calendar actives, inbox rule actives, etc.), or other user-related data sources that may correspond to expected travel activity by the digital user.

As used herein, “travel-related indicators” may correspond to predetermined strings, keywords, or patterns that represent or imply that the digital user is traveling, will be traveling, or is otherwise expected to authenticate from a different geographical region. Non-limiting examples of travel-related indicators may include textual strings such as “Paid Time Off,” “PTO,” “Vacation,” “Travel,” “OOO,” “Out of Office,” “Reservation,” “Flight,” “Hotel,” “Itinerary,” or any other predetermined string or expression curated by the identity threat detection and response service that suggests, implies, or indicates user travel.

In one or more embodiments, S220 may function to determine whether any travel-related indicators or strings appear in one or more logs associated with the subject identity alert within a predetermined time span (for example, the past 24 hours, the past fourteen (14) days or the past thirty (30) days relative to the time the subject identity alert was generated, received, or obtained by the system or service implementing method 200). In response to detecting such travel-related indicators, S220 may function to compute a numerical value representing the user travel details feature for the subject identity alert.

For instance, in a non-limiting example, the system or service implementing method 200 may assess one or more logs associated with the digital user and detect that, three days prior to the subject identity alert, the user submitted or generated an “OOO” (Out of Office) message indicating upcoming travel. Because “OOO” is included in a predetermined set of travel-related indicators defined by the system or service implementing method 200, S220 may compute the user travel details feature value as one (1). In another non-limiting example, S220 may assess the one or more logs and determine that no travel-related textual indicators (such as “PTO,” “Vacation,” or “Reservation”) appear within the predetermined time span. Accordingly, S220 may compute the user travel details feature value as zero (0). Stated another way, the user travel details feature may correspond to a binary value that is set to one (1) when at least one travel-related indicator is detected within the predetermined assessment period and set to zero (0) when no such indicators are detected.

It shall be recognized that the user travel details feature may serve as an indicator of whether seemingly unusual authentication activity—such as access from an unfamiliar geographical region—may nevertheless be consistent with expected user behavior. A feature value of one (1) may indicate that travel-related logs or messages suggest the digital user is legitimately traveling, thereby reducing the likelihood that the subject identity alert reflects malicious activity. Conversely, a feature value of zero (0) may indicate that no travel-related indicators exist, which may increase the likelihood that authentication from a new or distant geographical region is unexpected, anomalous, or potentially malicious.

Stated another way, in one or more embodiments, an identity alert may be associated with a user and, in response, the system or service implementing method 200 may function to automatically determine, based on assessing log data, whether one or more travel-related indicators for the user appear in the log data. In such an embodiment, the system or service implementing method 200 may function to compute, based on the automatic determining, a feature value for a user travel details feature, wherein: the feature value for the user travel details feature is one when at least one travel-related text string for the user is detected in the log data, and the feature value for the user travel details feature is zero when no travel-related text string for the user is detected in the log data. It shall be recognized that, in one or more embodiments, the identity alert feature vector generated for the identity alert may include the feature value for the user travel details feature.

### Suspicious Electronic Inbox Rule Creation Feature

Additionally, or alternatively, in one or more embodiments, in response to obtaining the subject identity alert, S220 may function to automatically compute, for the subject identity alert, a suspicious electronic inbox rule creation feature value for the subject identity alert. In one or more embodiments, the suspicious electronic inbox rule creation feature value computed for the subject identity alert may also be referred to herein as the feature value for the suspicious electronic inbox rule creation feature.

In one or more embodiments, S220 may function to compute, determine, and/or extract, in real time or near real time, a feature value corresponding to the suspicious electronic inbox rule creation feature for the subject identity alert. In such embodiments, S220 may function to automatically assess one or more email-system logs, mailbox audit logs, rule-creation logs, or other messaging-related data records associated with the digital user (or the subscribing entity) to detect whether the digital user created any electronic inbox rules within the predetermined time span (for example, the past seven (7) days, past fourteen (14) days, or past thirty (30) days relative to the time the subject identity alert was obtained, generated, or received by the system or service implementing method 200). Accordingly, in one or more embodiments, in response to detecting the digital user created one or more electronic inbox rules during the predetermined time span, S220 may further function to determine whether any of the one or more electronic inbox rules correspond to suspicious inbox rule patterns or configurations.

As used herein, a “suspicious inbox rule” may correspond to any mailbox rule, filter, or automated email-handling configuration that deviates from expected user behavior or is commonly associated with malicious or suspicious activity. Non-limiting examples of suspicious inbox rules may include rules that automatically forward all inbound messages to an external email address; rules that move or route inbound messages to obscure or rarely accessed folders; rules that immediately delete messages upon receipt; rules that suppress or redirect security notifications, authentication alerts, or system-generated warnings; or any other inbox rule configuration identified by the identity threat detection and response service as suspicious. Stated another way, suspicious inbox rules may include any rule that attackers commonly use to forward, hide, or delete emails to conceal unauthorized activity or exfiltrate sensitive information.

In one or more embodiments, S220 may function to determine whether any electronic inbox rule created within the predetermined time span satisfies one or more suspicious electronic inbox rule criteria defined, curated, or otherwise recognized by the identity threat detection and response service and, in turn, compute a numerical value representing the suspicious electronic inbox rule creation feature for the subject identity alert.

For instance, in a non-limiting example, the system or service implementing method 200 may assess one or more email-system logs associated with the digital user or the subscribing entity and detect that, within the predetermined time span, the digital user (or another entity impersonating the digital user) created an electronic inbox rule that automatically forwards all inbound messages to an external email address. Because automatic external forwarding satisfies one or more suspicious inbox rule criteria defined by the identity threat detection and response service, S220 may compute the suspicious electronic inbox rule creation feature value as one (1) for the subject identity alert.

In another non-limiting example, the system or service implementing method 200 may assess one or more email-system logs associated with the digital user or the subscribing entity and detect that, within the predetermined time span, the digital user (or another entity impersonating the digital user) created an inbox rule that automatically moves inbound messages containing security notifications, authentication alerts, or system-generated warnings into an obscure or rarely accessed folder. Because such message-hiding behavior satisfies one or more suspicious inbox rule criteria defined by the identity threat detection and response service, S220 may compute the suspicious electronic inbox rule creation feature value as one (1) for the subject identity alert.

Conversely, in another non-limiting example, S220 may assess the one or more logs and determine that none of the inbox rules created during the predetermined time span satisfy any suspicious inbox rule criteria, in which case S220 may compute the suspicious electronic inbox rule creation feature value as zero (0) for the subject identity alert. Stated another way, the suspicious electronic inbox rule creation feature may correspond to a binary indicator that is set to one (1) when at least one inbox rule created during the predetermined time span satisfies a suspicious inbox rule criterion of the identity threat detection and response service and set to zero (0) when no such rule is detected.

It shall be recognized that the suspicious electronic inbox rule creation feature may serve as an indicator of whether the subject identity alert is associated with potentially malicious or unauthorized mailbox manipulation. A feature value of one (1) may indicate elevated risk by suggesting that the digital user’s mailbox has been modified in a manner consistent with known attacker behaviors, such as hiding phishing emails, suppressing alerts, or exfiltrating inbound communications. Conversely, a feature value of zero (0) may indicate that no suspicious inbox rule activity was detected during the predetermined time span, thereby reducing the likelihood that the subject identity alert reflects malicious inbox manipulation or compromised account behavior.

Stated another way, in one or more embodiments, an identity alert may be associated with a digital user and, in response, the system or service implementing method 200 may function to detect, based on assessing log data, that the digital user created at least one electronic inbox rule during a predetermined time span. In such an embodiment, in response to detecting that the digital user created the at least one electronic inbox rule during the predetermined time span, the system or service implementing method 200 may function to assess whether the at least one electronic inbox rule satisfies a suspicious electronic inbox rule criterion. Accordingly, in such an embodiment, the system or service implementing method 200 may function to compute, based on the assessing of the at least one electronic inbox rule, a feature value for a suspicious electronic inbox rule creation feature, wherein the feature value for the suspicious electronic inbox rule creation feature is one when the at least one electronic inbox rule satisfies the suspicious electronic inbox rule criterion, and the feature value for the suspicious electronic inbox rule creation feature is zero when the at least one electronic inbox rule fails to satisfy the suspicious electronic inbox rule criterion. It shall be recognized that, in such an embodiment, the identity alert feature vector generated for the identity alert may include the feature value for the suspicious electronic inbox rule creation feature.

### New MFA Device Registration Feature

Additionally, or alternatively, in one or more embodiments, in response to obtaining the subject identity alert, S220 may function to automatically compute, for the subject identity alert, a new MFA device registration feature value for the subject identity alert. In one or more embodiments, the new MFA device registration feature value computed for the subject identity alert may also be referred to herein as the feature value for the new MFA device registration feature.

In one or more embodiments, S220 may function to compute, determine, and/or extract, in real time or near real time, a feature value corresponding to the new MFA device registration feature for the subject identity alert. In such embodiments, S220 may function to automatically assess one or more identity-management logs, MFA enrollment logs, audit logs, or device-registration records associated with the digital user or subscribing entity to detect whether any new MFA devices were registered after the digital user or an entity impersonating the digital user successfully logged in to the target computing environment.

As used herein, a “new MFA device registration” may correspond to any event in which the digital user (or an entity impersonating the digital user) adds, enrolls, registers, or activates a new MFA device following a successful authentication event. Such new registrations may include the addition of authenticator applications, hardware tokens, phone-based MFA factors, strong MFA credentials, or any other MFA mechanism. In some embodiments, attackers who compromise an account may register their own MFA device after logging in to create a persistent back door that enables them to authenticate in future sessions even if passwords or other credentials are changed.

In one or more embodiments, S220 may function to determine whether any new MFA device registration events occurred following a successful login and, in turn, compute a numerical value representing the new MFA device registration feature for the subject identity alert. For instance, in a non-limiting example, the system or service implementing method 200 may assess identity-management logs associated with the digital user and detect that, shortly after a successful authentication event that led to the subject identity alert, a new MFA device was registered from the same internet protocol address. In such an example, S220 may compute the new MFA device registration feature value as one (1). In another non-limiting example, S220 may determine that no such new MFA device registrations occurred and may compute the feature value as zero (0). Stated another way, the new MFA device registration feature may correspond to a binary indicator that is set to one (1) when at least one new MFA device registration event is detected after the digital user (or an entity impersonating the digital user) successfully logged in to the target computing environment and set to zero (0) when no such registrations are detected.

It shall be recognized that the new MFA device registration feature (e.g., binary-type feature) may serve as an indicator of potentially unauthorized account modification or post-compromise persistence techniques. A feature value of one (1) may indicate elevated risk that an attacker added a new MFA device after gaining access to maintain long-term persistence, whereas a value of zero (0) may indicate that no unusual MFA device modifications occurred, thereby reducing the likelihood that the subject identity alert reflects malicious activity.

### Deletion Events from User and IP Address Feature

Additionally, or alternatively, in one or more embodiments, in response to obtaining the subject identity alert, S220 may function to automatically compute, for the subject identity alert, a deletion events from user and IP address feature value for the subject identity alert. In one or more embodiments, the deletion events from user and IP address feature value computed for the subject identity alert may also be referred to herein as the feature value for the deletion events from user and IP address feature.

In one or more embodiments, S220 may function to compute, determine, and/or extract, in real time or near real time, a feature value corresponding to the deletion events from user and IP address feature for the subject identity alert. In such embodiments, S220 may function to automatically assess one or more logs, audit records, or data repositories associated with the digital user or the subscribing entity to detect deletion-related actions, tasks, or events that were performed from the internet protocol address specified in the subject identity alert. Stated another way, S220 may function to determine the total number of deletion events attributable to the digital user and originating from the internet protocol address specified in the subject identity alert during the predetermined time span (for example, the past seven (7) days, fourteen (14) days, or thirty (30) days relative to a time the system or service received, generated, or obtained the subject identity alert).

As used herein, a “deletion event” may correspond to any action in which the digital user removes, destroys, or otherwise eliminates data, artifacts, or records within the target computing environment. Non-limiting examples may include deleting emails from an inbox or folder, deleting files or documents, removing messages from collaboration platforms, clearing activity logs, deleting authentication artifacts, or issuing administrative deletion commands. In one or more embodiments, S220 may function to aggregate only those deletion events that were performed from the internet protocol address included in the subject identity alert and attributable to the digital user.

In one or more embodiments, S220 may function to automatically detect whether the total number of deletion events performed from the internet protocol address specified in the subject identity alert and attributable to the digital user meets or exceeds a minimum deletion-event threshold defined by the identity threat detection and response service. The minimum deletion-event threshold, in one or more embodiments, may correspond to one or more predetermined numeric values that represent unusually high or suspicious volumes of deletion activity. For instance, in a non-limiting example, the identity threat detection and response service may define a minimum deletion-event threshold of at least thirty (30) deletion events within the predetermined time span (for example, the past seven (7) days, fourteen (14) days, or thirty (30) days).

For instance, in a non-limiting example, the identity threat detection and response service may determine that the digital user (or an entity impersonating the digital user) performed at least thirty (30) deletion events from the internet protocol address specified in the subject identity alert within the predetermined time span. In such a non-limiting example, because the total number of deletion events meets or exceeds the minimum deletion-event threshold of thirty (30), S220 may compute the deletion events from user and IP address feature value as one (1). Conversely, when the total number of deletion events performed from the internet protocol address specified in the subject identity alert and attributable to the digital user falls below the minimum deletion-event threshold (for example, fewer than thirty (30) deletion events), S220 may compute the feature value as zero (0).

Stated another way, the deletion events from user and IP address feature may correspond to a binary indicator that is set to one (1) when the number of deletion events attributable to the digital user and originating from the internet protocol address specified in the subject identity alert meets or exceeds the predetermined minimum deletion-event threshold (for example, at least thirty (30), at least one hundred (100), or at least three hundred (300) deletion events) and set to zero (0) when no such threshold is satisfied.

It shall be recognized that the deletion events from user and IP address feature may serve as an indicator of whether the subject identity alert is associated with potentially malicious or non-malicious activity. A feature value of one (1) may indicate unusually high or abnormal volumes of deletion activity, which may suggest attempts to conceal unauthorized actions, remove evidence of access, or otherwise degrade auditability within the target computing environment. Conversely, a feature value of zero (0) may indicate that deletion activity falls within expected norms for the digital user, thereby reducing the likelihood that the observed behavior is malicious.

### Geo-Impossible Travel Feature

Additionally, or alternatively, in one or more embodiments, in response to obtaining the subject identity alert, S220 may function to automatically compute, for the subject identity alert, a geo-impossible travel feature value for the subject identity alert. In one or more embodiments, the geo-impossible travel feature value computed for the subject identity alert may also be referred to herein as the feature value for the geo-impossible travel feature.

As used herein, “geo-impossible travel” may correspond to any scenario in which two sequential login events associated with the digital user occur from geographically distant locations at times too close together to permit physically possible travel between the two locations.

In one or more embodiments, S220 may function to compute, determine, and/or extract, in real time or near real time, a feature value corresponding to the geo-impossible travel feature for the subject identity alert. In such embodiments, S220 may function to automatically obtain all login events corresponding to the digital user that occurred within the predetermined time span (for example, the past thirty (30) days relative to a time the system or service implementing method 200 received, generated, or obtained the subject identity alert) and, in turn, S220 may function to arrange the obtained login events in chronological order from earliest occurrence to latest occurrence and, in turn, evaluate each login event relative to the immediately preceding login event in the ordered sequence.

In one or more embodiments, S220 may function to determine, for each pair of sequential login events, whether the travel required to move from the geographic location associated with the earlier login event to the geographic location associated with the later login event is physically possible within the elapsed time between the two login events. In such embodiments, S220 may function to compute a distance between the two locations, determine the time difference between the login events, and/or evaluate whether the implied travel speed exceeds a maximum feasible travel speed. In one or more embodiments, when the implied travel speed exceeds the maximum feasible travel speed, S220 may classify the transition as geo-impossible travel.

In one or more embodiments, in response to determining that at least one sequential pair of login events within the predetermined time span constitutes geo-impossible travel, S220 may function to compute the geo-impossible travel feature value as one (1). Conversely, when no sequential pair of login events constitutes geo-impossible travel, S220 may compute the geo-impossible travel feature value as zero (0). Stated another way, the geo-impossible travel feature may correspond to a binary indicator that is set to one (1) when at least one travel transition between login events is physically impossible given the available time interval and, in turn, set to zero (0) when all such transitions are physically plausible.

For instance, in a non-limiting example, S220 may obtain all login events associated with the digital user during the predetermined time span (for example, the past thirty (30) days relative to when the system or service implementing method 200 received, generated, or obtained the subject identity alert) and arrange them in chronological order from earliest to latest. After ordering the events, S220 may evaluate each login event against the next sequential event to determine whether the required travel between the two geographic locations is physically possible given the time elapsed. For example, the first login event associated with the digital user may occur on January 4, 2025 at 08:10:00 (UTC-05:00) from New York, USA. The next login event associated with the digital user may occur on January 4, 2025 at 10:20:00 (UTC-05:00) from Boston, USA. Because New York and Boston are approximately 215 miles apart and two hours and ten minutes elapsed between the login events, S220 may determine that the travel is physically plausible. The system may then compare the Boston login on January 4, 2025 at 10:20:00 to the next sequential login event associated with the digital user, which may occur on January 4, 2025 at 10:21:00 (UTC-06:00) from Chicago, USA. Because the distance between Boston and Chicago is roughly 850 miles and only one minute elapsed between the login events—even after accounting for time zone differences—the required travel speed would exceed plausible human travel capability, and S220 may therefore determine that this user location transition constitutes geo-impossible travel. Next, S220 may evaluate the login event in Chicago on January 4, 2025 at 10:21:00 against a subsequent login event occurring on January 4, 2025 at 11:20:00 (UTC-06:00), also in Chicago, USA. Because the locations are identical, S220 may determine that this user location transition is physically plausible. Finally, S220 may evaluate the Chicago login on January 4, 2025 at 11:20:00 against the next login event associated with the digital, which may occur on January 5, 2025 at 09:30:00 (UTC+09:00) in Tokyo, Japan. Although the distance is significant—more than 6,000 miles—the elapsed time of nearly twenty-two hours is consistent with the duration of international travel, and S220 may therefore determine that this user location transition is also physically plausible.

It shall be recognized that the geo-impossible travel feature may serve as an indicator of whether the authentication activity associated with the subject identity alert reflects anomalous or potentially malicious behavior. A feature value of one (1) may indicate that the digital user appears to authenticate from geographically distant locations in an unrealistic timeframe, which may suggest credential theft, session hijacking, or unauthorized access. Conversely, a feature value of zero (0) may indicate that the digital user’s authentication locations fall within expected, physically plausible travel patterns, thereby reducing the likelihood of malicious activity.

Stated another way, in one or more embodiments, an identity alert is associated with a user. In such an embodiment, the system or service implementing method 200 may function to obtain, based on assessing authentication log data, a plurality of login events corresponding to the user that occurred within a predetermined time span and, in response, construct, based on obtaining the plurality of login events, an authentication event sequence data structure for the user that includes the plurality of login events in chronological order. Furthermore, in such an embodiment, the system or service implementing method 200 may function to assess at least one pair of sequential login events included in the authentication event sequence data structure to determine whether travel between (i) a first distinct geographical location associated with a first login event included in the at least one pair of sequential login events and (ii) a second distinct geographic location associated with a second login event included in the at least one pair of sequential login events is physically possible based on an amount of time elapsed between the first login event and the second login event.

Accordingly, in such an embodiment, the system or service implementing method 200 may function to compute, based on the assessing of the at least one pair of sequential login events, a feature value for a subject feature, wherein the feature value of the subject feature is one when the at least one pair of sequential login events requires travel by the user from the first distinct geographical location to the second distinct geographic location at a speed that exceeds a predetermined maximum travel speed threshold, and the feature value of the subject feature is zero when the at least one pair of sequential login events requires travel by the user from the first distinct geographical location to the second distinct geographic location at the speed that does not exceed the predetermined maximum travel speed threshold. It shall be recognized that the identity alert feature vector generated for the identity alert may include the feature value for the subject feature.

### New User Account Feature

Additionally, or alternatively, in one or more embodiments, in response to obtaining the subject identity alert, S220 may function to automatically compute, for the subject identity alert, a new user account feature value for the subject identity alert. In one or more embodiments, the new user account feature value computed for the subject identity alert may also be referred to herein as the feature value for the new user account feature.

In one or more embodiments, S220 may function to compute, determine, and/or extract, in real time or near real time, a feature value corresponding to the new user account feature for the subject identity alert. In such embodiments, S220 may function to automatically assess one or more logs associated with subject identity alert or the subscribing entity to detect whether the digital user involved in the subject identity alert created one or more new user accounts within a predetermined time span (for example, the past seven (7) days, fourteen (14) days, or thirty (30) days relative to when the system or service implementing method 200 received, generated, or obtained the subject identity alert).

As used herein, a “new user account creation event” may correspond to any action in which the digital user provisions, registers, or otherwise creates an additional user identity within the target computing environment. Non-limiting examples may include creating new user accounts, creating new administrative or privileged accounts, creating new service accounts, or initiating automated processes that result in the creation of new user identities.

In one or more embodiments, S220 may function to determine whether any new user account creation events attributable to the digital user occurred during the predetermined time span. In one or more embodiments, in response to making such a determination, S220 may compute a numerical value representing the new user account feature for the subject identity alert. For instance, in a non-limiting example, the new user account feature value may be zero (0) when the system or service implementing method 200 determines that the digital user did not create any new user accounts within the predetermined time span. In another non-limiting example, the new user account feature value may be one (1) when S220 determines that the digital user created at least one new user account during the predetermined time span.

Stated another way, the new user account feature may correspond to a binary indicator that is set to one (1) when the digital user created one or more new user accounts within the predetermined time span and set to zero (0) when no such account-creation activity is detected.

It shall be recognized that the new user account feature may serve as an indicator of whether the subject identity alert is associated with potentially unauthorized or malicious activity. A new user account feature value of one (1) may indicate that the digital user is creating additional user accounts, which may suggest privilege escalation, persistence establishment, lateral movement preparation, or attacker behavior aimed at creating alternate access paths. Conversely, a new user account feature value of zero (0) may indicate that the digital user has not recently created new user accounts, thereby reducing the likelihood that the subject identity alert reflects malicious account-creation activity.

### Electronic Communication Features

Additionally, or alternatively, in one or more embodiments, in response to obtaining the subject identity alert, S220 may function to compute any of the one or more electronic communication-type features described in U.S. Patent No. 12,120,147, titled SYSTEMS AND METHODS FOR INTELLIGENT IDENTIFICATION AND AUTOMATED DISPOSAL OF NON-MALICIOUS ELECTRONIC COMMUNICATIONS, which is incorporated in its entirety herein.

In one or more embodiments, when the subject identity alert is associated with, derived, or otherwise generated based on the digital user electronically receiving an electronic communication, S220 may function to compute, in real-time or near real-time, feature values for the one or more electronic communication-type features using or based in part on the electronic communication the digital user electronically received.

### New User Agent Feature

Additionally, or alternatively, in one or more embodiments, in response to obtaining the subject identity alert, S220 may function to automatically compute, for the subject identity alert, a new user agent feature value for the subject identity alert. In one or more embodiments, the new user agent feature value computed for the subject identity alert may also be referred to herein as the feature value for the new user agent feature.

In one or more embodiments, S220 may function to compute, determine, and/or extract, in real time or near real time, a feature value corresponding to the new user agent feature for the subject identity alert. In such embodiments, S220 may function to automatically assess one or more logs associated with the digital user or the subscribing entity to detect the user agent string used in connection with the authentication event that generated the subject identity alert. In one or more embodiments, S220 may further function to compare the detected user agent string with a historical set of user agent strings previously associated with successful authentication events performed by the digital user within a predetermined time span (for example, the past seven (7) days, fourteen (14) days, or thirty (30) days).

In one or more embodiments, S220 may function to determine whether the user agent string detected for the authentication event is new, unfamiliar, or otherwise not historically associated with the digital user during the predetermined time span and, in turn, S220 may compute a numerical value representing the new user agent feature for the subject identity alert. For instance, in a non-limiting example, S220 may compute a feature value of zero (0) when the detected user agent string appears within the digital user’s historical user agent set for the predetermined time span. In another non-limiting example, S220 may compute a feature value of one (1) when the detected user agent string does not appear within the historical set and is therefore considered new for the digital user.

Stated another way, the new user agent feature may correspond to a binary indicator that is set to one (1) when the user agent used in the authentication event is new or otherwise has not been historically observed for the digital user within the predetermined time span, and set to zero (0) when the user agent corresponds to one previously observed for the digital user.

It shall be recognized that the new user agent feature may serve as an indicator of whether the subject identity alert is associated with expected or unexpected authentication behavior. A feature value of one (1) may indicate that the authentication attempt used a new or unfamiliar user agent, thereby increasing the likelihood that the activity is anomalous or potentially malicious. Conversely, a feature value of zero (0) may indicate that the authentication event used a user agent consistent with the digital user’s historical behavior, reducing the likelihood that the observed activity is malicious.

### 2.30 Computing Identity Alert Inferences

S230, which includes computing machine learning-based identity alert inferences, may function to compute, using one or more machine learning classification models, one or more machine learning-based identity alert threat inferences for a target identity alert using the identity alert feature vector that corresponds to the target identity alert. In one or more embodiments, the one or more machine learning-based identity alert inferences computed for the target identity alert may include a probability or a likelihood of the target identity alert being a benign security alert. It shall be recognized that the phrase “machine learning-based identity alert inference” may be interchangeably referred to herein as an “identity alert classification inference,” an “identity alert inference,” “an identity alert threat inference,” and/or the like.

In one or more embodiments, in response to S220 generating, in real-time or near real-time, an identity alert feature vector for a subject identity-based alert, S230 may function to compute, using one or more machine learning classification models, a machine learning-based identity alert inference for the subject identity-based alert that includes a probability, a likelihood, and/or a confidence score of the subject identity-based alert being a benign security alert (e.g., benign identity-based alert).

In a first implementation, S230 may function compute, using a single machine learning classification model (e.g., identity alert machine learning classification model), the machine learning-based identity alert inference for the subject identity-based alert based on providing the identity alert feature vector as input to the single machine learning classification model. It shall be recognized that the phrase “single machine learning classification model” may be interchangeably referred to herein as an “identity alert machine learning classification model,” “identity alert machine learning threat classification model” and/or the like.

For instance, in a non-limiting example, the machine learning-based identity alert inference outputted by the single machine learning classification model may include a probability, a likelihood, and/or a confidence score of ninety-seven (97) for the subject identity-based alert. In such a non-limiting example, the probability, the likelihood, and/or the confidence score of ninety-seven (97) indicates a high likelihood that the subject identity-based alert is a benign or not malicious security alert (e.g., benign or not malicious identity-based alert).

In another non-limiting example, the machine learning-based identity alert inference outputted by the single machine learning classification model may include a probability, a likelihood, and/or a confidence score of twenty (20) for the subject identity-based alert. In such a non-limiting example, the probability, the likelihood, and/or the confidence score of twenty (20) indicates a low likelihood that the subject identity-based alert is a benign or not malicious security alert (e.g., the subject identity-based alert poses a security threat to the subscribing entity, the subject identity-based alert poses is indicative of malicious user activity, the subject identity-based alert is not a benign security alert, etc.).

In a second implementation, S230 may function to compute, using an ensemble of machine learning classification models, the machine learning-based identity alert inference for the subject identity-based alert. In such an embodiment, the ensemble of machine learning classification models (e.g., an ensemble of XGBoost machine learning models, an ensemble of gradient-boosted decision tree models, an ensemble of neural network-based models, or any suitable combination thereof) may be operably configured to generate the machine learning-based identity alert inference for the subject identity-based alert based on assessing the identity alert feature vector generated for the subject identity-based alert. It shall be recognized that, in some embodiments, the ensemble of machine learning classification models may include at least two distinct XGBoost machine learning models, at least three distinct XGBoost machine learning models, at least four distinct XGBoost machine learning models, at least five distinct XGBoost machine learning models, at least six distinct XGBoost machine learning models, at least seven distinct XGBoost machine learning models, at least nine distinct XGBoost machine learning models, at least ten distinct XGBoost machine learning models, or any other suitable number of XGBoost machine learning models. It shall be recognized that the phrase “the ensemble of machine learning classification models” may be interchangeably referred to herein as an “ensemble of identity alert machine learning classification models,” an “ensemble of identity alert machine learning threat classification models” and/or the like.

For instance, in a non-limiting example, the ensemble of machine learning classification models may include a first distinct XGBoost machine learning model (e.g., first distinct binary classification machine learning model) and a second distinct XGBoost machine learning model (e.g., second distinct binary classification machine learning model). In such a non-limiting example, the identity alert feature vector generated for the subject identity-based alert may be provided, as input, to the first distinct XGBoost machine learning model and the second distinct XGBoost machine learning model and, in turn, the first distinct XGBoost machine learning model may function to output a first intermediate inference that indicates a probability, a likelihood, or confidence score that the subject identity-based alert is a benign or non-malicious alert, while the second distinct XGBoost machine learning model may function to output a second intermediate inference that indicates a probability, a likelihood, or confidence score that the subject identity-based alert is a benign or non-malicious alert.

Accordingly, in response to computing the first intermediate inference and the second intermediate inference, the system or service implementing method 200 may function to generate the machine learning-based identity alert inference for the subject identity-based alert based on aggregating, fusing, or otherwise combining the first intermediate inference and the second intermediate inference. It shall be recognized that the machine learning-based identity alert inference, in such an embodiment, may include an ensemble-based value derived from the first and second intermediate inferences that represents a combined likelihood, probability, or confidence score of the subject identity-based alert being a benign or non-malicious alert.

For instance, in a non-limiting example, the first distinct XGBoost machine learning model may output a first intermediate inference having a confidence score of ninety-two (92), indicating a high likelihood that the subject identity-based alert is benign or non-malicious, while the second distinct XGBoost machine learning model may output a second intermediate inference having a confidence score of eighty-six (86), also indicating a high likelihood the subject identity-based alert is benign or non-malicious. In such a non-limiting example, the system or service implementing method 200 may aggregate or average the first and second intermediate inferences to compute an ensemble-based identity alert inference having a combined confidence score (e.g., ensemble-based value or the like) of eighty-nine (89). As described in more detail herein, the ensemble-based identity alert inference of eighty-nine (89) may indicate that the subject identity-based alert is highly likely to be benign, and, in turn, the system or service implementing method 200 may automatically close the subject identity-based alert and/or mark the subject identity-based alert as resolved within the identity threat detection and response service to reduce alert queue volume and minimize unnecessary analyst triage.

In one or more embodiments, the system or service implementing method 200 may function to generate an identity alert feature vector that corresponds to a subject identity alert. The identity alert feature vector generated for the subject identity alert, in one or more embodiments, may include the feature value of the internet protocol address user prevalence feature value computed for the subject identity alert, the feature value of the internet protocol address environment prevalence feature computed for the subject identity alert, the feature value of the internet protocol address organization prevalence feature computed for the subject identity alert, the feature value for the ASN prevalence feature computed for the subject identity alert, the feature value of the geographical region prevalence feature computed for the subject identity alert, the feature value of the VPN user prevalence feature computed for the subject identity alert, the feature value of the VPN environment prevalence feature computed for the subject identity alert, the feature value of the hosting user prevalence feature computed for the subject identity alert, the feature value of the deletion event feature computed for the subject identity alert, the feature value of the consecutive MFA failure feature computed for the subject identity alert, the feature value of the malicious attribute feature computed for the subject identity alert, the feature value of the MFA device IP association feature computed for the subject identity alert, the feature value for the valid MFA device feature computed for the subject identity alert, the feature value of the strong MFA device feature computed for the subject identity alert, the feature value of the weak MFA device feature computed for the subject identity alert, the feature value of the user agent feature computed for the subject identity alert, the feature value of the user travel details feature computed for the subject identity alert, the feature value of the suspicious electronic inbox rule creation feature computed for the subject identity alert, the feature value of the new MFA device registration feature computed for the subject identity alert, the feature value of the deletion events from user and IP address feature computed for the subject identity alert, the feature value of the geo-impossible travel feature computed for the subject identity alert, the feature value of the new user account feature computed for the subject identity alert, each feature value of the one or more electronic communication features computed for the subject identity alert, and/or the feature value of the new user agent feature computed for the subject identity alert.

Accordingly, in one or more embodiments, in response to generating the identity alert feature vector for the subject identity alert, S230 may function to provide, as input, the identity alert feature vector to a first machine learning model (e.g., a first machine learning classification model, a first XGBoost machine learning model, etc.) and a second machine learning model (e.g., a second machine learning classification model, a second XGBoost machine learning model, etc.). Accordingly, in response to providing the identity alert feature vector generated for the subject identity alert to the first machine learning model, the first machine learning model may function to output a first inference (e.g., a first identity alert threat inference or the like) that includes a confidence score (e.g., probability) of the subject identity alert being or corresponding to a non-malicious identity alert. Furthermore, in such an embodiment, in response to providing the identity alert feature vector generated for the subject identity alert to the second machine learning model, the second machine learning model may function to output a second inference (e.g., a second identity alert threat inference or the like) that includes a confidence score (e.g., probability) of the subject identity alert being or corresponding to a benign identity alert.

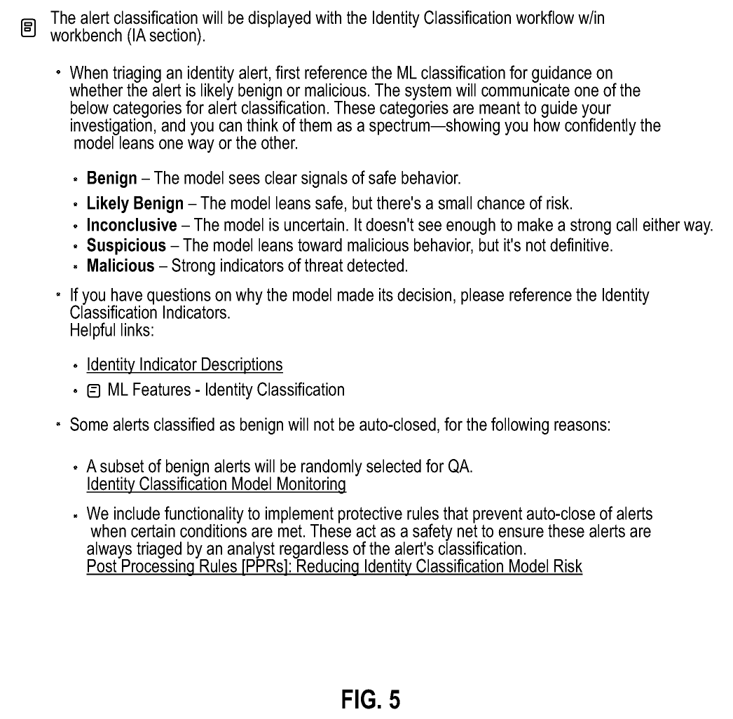

A non-malicious identity alert, in some embodiments, may refer to an identity-related security alert that reflects expected, routine, or otherwise legitimate behavior by the digital user and lacks any indication of unauthorized access or malicious activity, as shown generally by way of example in FIG. 5. Non-malicious identity alerts may arise when the digital user performs authentication actions, access operations, or account-related activities that trigger an alert condition but are nevertheless consistent with the user’s historical patterns, authorized roles, environmental context, or legitimate operational needs. For example, non-malicious identity alerts may correspond to routine password resets, logins from familiar devices or locations, valid MFA behavior, or other identity-related events that do not exhibit indicators of compromise, anomalous activity, or malicious intent.

A benign identity alert, in some embodiments, may refer to an identity-related security alert that reflects harmless, expected, or otherwise low-risk behavior by the digital user and does not indicate any meaningful security concern, as shown generally by way of example in FIG. 5. Benign identity alerts may correspond to alert conditions that are technically triggered by system logic but, upon assessment, align with normal user behavior, administrative workflows, or standard operational activity. Non-limiting examples of benign identity alerts may include logins associated with trusted automation, background synchronization processes, legitimate system-generated events, or other identity-related activities that present no indication of compromise, malicious intent, or anomalous authentication behavior.

### Training the Ensemble of Identity Alert Machine Learning Classification Models

In one or more embodiments, the system or system implementing method 200 may function to configure the ensemble of machine learning classification models based in part on one or more corpora of training data. In one or more embodiments, the system or service implementing method 200 may function to curate, source, or obtain one or more corpora of training data and train the ensemble of machine learning classification models using the one or more corpora of training data.

In one or more embodiments, the system or system implementing method 200 may function to obtain, from a computer database of the identity threat detection and response service, all historical identity-based alerts that occurred in a target period. For instance, in a non-limiting example, the system or system implementing method 200 may function to source all historical identity-based alerts that occurred in a target year (e.g., 01-JAN-2024 to 01-JAN-2025). Accordingly, in such a non-limiting example, based on or in response to sourcing all historical identity-based alerts that occurred in the target year, the system or service implementing method 200 may function to extract, from the historical identity-based alerts that occurred in the target year, (i) a first set of malicious identity-based alerts that includes all identity-based alerts that were determined by the identity threat detection and response service to be malicious and/or resulted in a security incident, and (ii) a second set of non-malicious identity-based alerts that includes a plurality of identity-based alerts that were determined by the identity threat detection and response service to be non-malicious and/or did not result in a security incident.

It shall be recognized that, in such a non-limiting example, the system or service implementing method 200 may function to execute a random sampling process to obtain the plurality of identity-based alerts of the second set of non-malicious identity-based alerts. It shall be further recognized that each identity-based alert in the first set of malicious identity-based alerts is assigned a malicious alert label, while each identity-based alert in the second set of non-malicious identity-based alerts is assigned a non-malicious alert label.

In one or more embodiments, a total number of non-malicious identity-based alerts included in the second set of non-malicious identity-based alerts may be less than a total number of non-malicious identity-based alerts that occurred in the target year. In such embodiments, the system or service implementing method 200 may function to include in the second set of non-malicious identity-based alerts only a stratified random sample of the substantially larger population of non-malicious identity-based alerts.

It shall be further recognized that, in one or more embodiments, a total number of non-malicious identity-based alerts (e.g., 500, 2000, etc.) included in the second set of non-malicious identity-based alerts may be substantially less than a total number of malicious identity-based alerts (e.g., 23,000, etc.) included in the first set of malicious identity-based alerts. Accordingly, in one or more embodiments, to resolve a class imbalance between the comparatively underrepresented second set of non-malicious identity-based alerts and the comparatively overrepresented first set of malicious identity-based alerts, the system or service implementing method 200 may function to provide, as input, the first set of malicious identity-based alerts and/or the second set of non-malicious identity-based alerts to a synthetic minority oversampling technique (SMOTE) algorithm configured to generate synthetic non-malicious identity-based alerts. In such embodiments, the SMOTE algorithm may function to interpolate or synthetically generate new non-malicious identity-based alert samples using the feature space of the second set of non-malicious identity-based alerts, thereby increasing the effective representation of non-malicious identity-based alerts so that the one or more corpora of training data exhibits a more balanced or semi-balanced distribution of malicious and non-malicious identity-based alerts for training the ensemble of machine learning classification models.

Stated another way, in one or more embodiments, the one or more corpora of training data (e.g., one or more corpora of identity alert training data or the like) may include (i) a first set of malicious identity-based alerts, wherein each identity-based alert included in the first set of malicious identity-based alerts is attributed a malicious alert classification label, (ii) a second set of non-malicious identity-based alerts, wherein each identity-based alert included in the second set of malicious identity-based alerts is attributed a non-malicious alert classification label, and (iii) a third set of synthetically generated non-malicious identity-based alerts, wherein each identity-based alert included in the third set of synthetically generated non-malicious identity-based alerts is attributed the non-malicious alert classification label.

Accordingly, in one or more embodiments, in response to generating the one or more corpora of training data (e.g., one or more corpora of identity alert training data or the like), the system or service implementing method 200 may function to train an ensemble of machine learning classification models using the one or more corpora of training data. Stated another way, in one or more embodiments, in response to generating the one or more corpora of training data (e.g., one or more corpora of identity alert training data or the like), the system or service implementing method 200 may function to training an ensemble of identity alert machine learning classification models using the one or more corpora of training data.

Alternatively, in one or more embodiments, the system or system implementing method 200 may function to obtain, from a computer database of the identity threat detection and response service, an initial set of historical identity alerts that occurred in a target period. For instance, in a non-limiting example, the initial set of historical identity alerts may include all historical identity alerts that occurred in a target year (e.g., 01-JAN-2024 to 01-JAN-2025).

In such an embodiment, the system or service implementing method 200 may function to source or extract, from the initial set of historical identity alerts, a first subset of malicious historical identity alerts that includes all malicious identity alerts that occurred in the target year. It shall be recognized that, in such an embodiment, the system or service implementing method 200 may function to attribute a malicious classification label to each malicious identity alert included in the first subset of malicious historical identity alerts.

Furthermore, in such an embodiment, the system or service implementing method 200 may function to source or extract, from the initial set of historical identity alerts, a second subset of non-malicious historical identity alerts that includes all non-malicious identity alerts that occurred in the target year. Additionally, in such an embodiment, the system or service implementing method 200 may function to execute a stratified sampling process on the second subset of non-malicious historical identity alerts to generate a reduced subset of historical non-malicious identity alerts. Accordingly, in such a non-limiting example, the reduced subset of historical non-malicious identity alerts includes a same number of non-malicious historical identity alerts in each month of the target year, thereby ensuring that the reduced subset reflects a balanced temporal distribution of non-malicious identity alerts across the entire target period. It shall be recognized that, in such an embodiment, the system or service implementing method 200 may function to attribute a non-malicious classification label to each non-malicious identity alert included in the reduced subset of non-malicious historical identity alerts.

Accordingly, in such an embodiment, the system or service implementing method 200 may function to train a first machine learning classification model (e.g., a first extreme gradient boosting machine learning model (e.g., a first XGBoost machine learning model) using the first subset of malicious historical identity alerts and the reduced subset of non-malicious historical identity alerts. It shall be recognized that, in such a non-limiting example, the reduced subset of non-malicious historical identity alerts may be generated such that the total number of non-malicious identity alerts included in the reduced subset is approximately three times greater than the total number of malicious identity alerts included in the first subset of malicious historical identity alerts. Stated another way, in one or more embodiments, the system or service implementing method 200 may function to curate a labeled training dataset in which the ratio of non-malicious identity alerts to malicious identity alerts is approximately 3:1.

It shall be further recognized that constructing the reduced subset of non-malicious historical identity alerts to include a uniform number of non-malicious identity alerts from each month of the target year reduces or prevents temporal or seasonal bias during training of the first machine learning classification model. For example, in a non-limiting scenario, the second subset of non-malicious historical identity alerts may include three hundred (300) non-malicious identity alerts that occurred in January, one hundred fifty (150) non-malicious identity alerts that occurred in February, and fifty (50) non-malicious identity alerts that occurred in March, with comparatively fewer non-malicious identity alerts occurring in other months of the target year. If the first machine learning classification model were trained using this temporally imbalanced set (e.g., the second subset of non-malicious historical identity alerts), the first machine learning model could become biased toward behavioral patterns or environmental conditions that are more prevalent during months with higher alert volumes. By contrast, in such an embodiment, the system or service implementing method 200 may construct the reduced subset of non-malicious historical identity alerts by selecting, for example, twenty-five (25) non-malicious identity alerts from each month of the target year. In this non-limiting example, the reduced subset includes a total of three hundred (300) non-malicious historical identity alerts (i.e., 25 alerts × 12 months), with each month contributing an equal number of non-malicious identity alerts, thereby reducing or preventing temporal or seasonal bias during training of the first machine learning classification model.

Additionally, in one or more embodiments, the system or system implementing method 200 may function to obtain, from a computer database of the identity threat detection and response service, an initial set of historical identity alerts that occurred in a target period. For instance, in a non-limiting example, the initial set of historical identity alerts may include all historical identity alerts that occurred in a target year (e.g., 01-JAN-2024 to 01-JAN-2025).

In such an embodiment, the system or service implementing method 200 may function to source or extract, from the initial set of historical identity alerts, a first subset of not benign historical identity alerts that includes all not benign identity alerts that occurred in the target year. It shall be recognized that, in such an embodiment, the system or service implementing method 200 may function to attribute a not benign classification label to each not benign identity alert included in the first subset of not benign historical identity alerts.

Furthermore, in such an embodiment, the system or service implementing method 200 may function to source or extract, from the initial set of historical identity alerts, a second subset of benign historical identity alerts that includes all benign identity alerts that occurred in the target year. Additionally, in such an embodiment, the system or service implementing method 200 may function to execute a stratified sampling process on the second subset of benign historical identity alerts to generate a reduced subset of historical benign identity alerts. Accordingly, in such a non-limiting example, the reduced subset of historical benign identity alerts includes a same total number of benign historical identity alerts across each month of the target year, thereby ensuring that the reduced subset reflects a balanced temporal distribution of benign identity alerts across the entire target period. It shall be recognized that, in such an embodiment, the system or service implementing method 200 may function to attribute a benign classification label to each benign identity alert included in the reduced subset of benign historical identity alerts.

Accordingly, in such an embodiment, the system or service implementing method 200 may function to train a second machine learning classification model (e.g., a second extreme gradient boosting machine learning model (e.g., a second XGBoost machine learning model) using the first subset of not benign historical identity alerts and the reduced subset of benign historical identity alerts. It shall be recognized that, in such a non-limiting example, the reduced subset of benign historical identity alerts may be generated such that the total number of benign identity alerts included in the reduced subset is approximately three times greater than the total number of not benign identity alerts included in the first subset of not benign historical identity alerts. Stated another way, in one or more embodiments, the system or service implementing method 200 may function to curate a labeled training dataset in which the ratio of benign identity alerts to not benign identity alerts is approximately 3:1.

It shall be further recognized that, in one or more embodiments, constructing the reduced subset of benign historical identity alerts to include a uniform number of benign identity alerts from each month of the target year reduces or prevents temporal or seasonal bias during training of the second machine learning classification model. For example, in a non-limiting scenario, the second subset of benign historical identity alerts may include four hundred (400) benign identity alerts that occurred in January, two hundred (200) benign identity alerts that occurred in February, and one hundred (100) benign identity alerts that occurred in March, with comparatively fewer benign identity alerts occurring in other months of the target year. If the second machine learning classification model were trained using this temporally imbalanced set (e.g., the second subset of benign historical identity alerts), the second machine learning classification model could become biased toward behavioral patterns, access patterns, or environmental conditions that are more prevalent during months with higher alert volumes. By contrast, in such an embodiment, the system or service implementing method 200 may construct the reduced subset of benign historical identity alerts by selecting, for example, thirty (30) benign identity alerts from each month of the target year. In this non-limiting example, the reduced subset includes a total of three hundred sixty (360) benign historical identity alerts (i.e., 30 alerts × 12 months), with each month contributing an equal number of benign identity alerts, thereby reducing or preventing temporal or seasonal bias during training of the second machine learning classification model.

### 2.40 Intelligent Identity Alert Handling

S240, which includes intelligent identity alert handling, may function to execute an identity alert handling action for a subject identity alert based on the one or more identity alert inferences computed for the subject identity alert.

As described above, in one or more embodiments, in response to generating the identity alert feature vector for the subject identity alert, S240 may function to route the identity alert feature vector generated for the subject identity alert to an ensemble of identity alert machine learning classification models. In such an embodiment, the identity alert feature vector generated for the subject identity alert may be simultaneously provided, as input, to the above-mentioned first machine learning model (e.g., the first XGBoost machine learning model) and the above-mentioned second machine learning model (e.g., the second XGBoost machine learning model).

Accordingly, in such an embodiment, the first machine learning model (e.g., the first XGBoost machine learning model) may function to output a first identity alert inference that includes a confidence score, a likelihood, or a probability of the subject identity alert being or corresponding to a non-malicious identity alert. For instance, in such a non-limiting example, the confidence score, the likelihood, or the probability predicted or computed by the first machine learning model for the subject identity alert may be 0.85. In another non-limiting example, the confidence score, the likelihood, or the probability predicted or computed by the first machine learning model for the subject identity alert may be 0.20. In another non-limiting example, the confidence score, the likelihood, or the probability predicted or computed by the first machine learning model for the subject identity alert may be 0.90. In another non-limiting example, the confidence score, the likelihood, or the probability predicted or computed by the first machine learning model for the subject identity alert may be any number between 0 and 1. It shall be recognized that, in general, a confidence score, a likelihood, or a probability closer to 1 may indicate that the first machine learning model has assessed the subject identity alert as more strongly aligned with characteristics of a non-malicious identity alert, whereas a confidence score, a likelihood, or a probability predicted closer to 0 may indicate that the first machine learning model has assessed the subject identity alert as more strongly aligned with characteristics of a potentially malicious identity alert.

Additionally, in such an embodiment, the second machine learning model (e.g., a second XGBoost machine learning model) may function to output a second identity alert inference that includes a confidence score, a likelihood, or a probability of the subject identity alert being or corresponding to a benign identity alert. For instance, in such a non-limiting example, the confidence score, the likelihood, or the probability predicted or computed by the second machine learning model for the subject identity alert may be 0.85. In another non-limiting example, the confidence score, the likelihood, or the probability predicted or computed by the second machine learning model for the subject identity alert may be 0.20. In another non-limiting example, the confidence score, the likelihood, or the probability predicted or computed by the second machine learning model for the subject identity alert may be 0.90. In another non-limiting example, the confidence score, the likelihood, or the probability predicted or computed by the second machine learning model for the subject identity alert may be any number between 0 and 1. It shall be recognized that, in general, a confidence score, a likelihood, or a probability closer to 1 may indicate that the second machine learning model has assessed the subject identity alert as more strongly aligned with characteristics of a benign identity alert, whereas a confidence score, a likelihood, or a probability predicted closer to 0 may indicate that the second machine learning model has assessed the subject identity alert as more strongly aligned with characteristics of a not benign identity alert.

In one or more embodiments, in response to the first machine learning model generating the first identity alert inference and the second machine learning model generating the second identity alert inference for the subject identity alert, S240 may function to assess the confidence score (e.g., probability) included in the first identity alert inference against the confidence score (e.g., probability) included in the second identity alert inference to determine a prevailing or dominant identity alert inference representing the more likely characterization of the subject identity alert. In such an embodiment, the prevailing or dominant identity alert inference may be the identity alert inference associated with the higher of the two confidence scores (e.g., higher of the two probabilities). For instance, in a non-limiting example, if the first identity alert inference includes a confidence score (e.g., probability) of 0.99 while the second identity alert inference includes a confidence score (e.g., probability) of 0.88, the first identity alert inference may be designated as the prevailing or dominant identity alert inference since 0.99 is higher than 0.88. Conversely, if the second identity alert inference includes a confidence score (e.g., probability) of 0.91 while the first identity alert inference includes a confidence score (e.g., probability) of 0.40, the second identity alert inference may be designated as the prevailing or dominant identity alert inference since 0.91 is higher than 0.40.

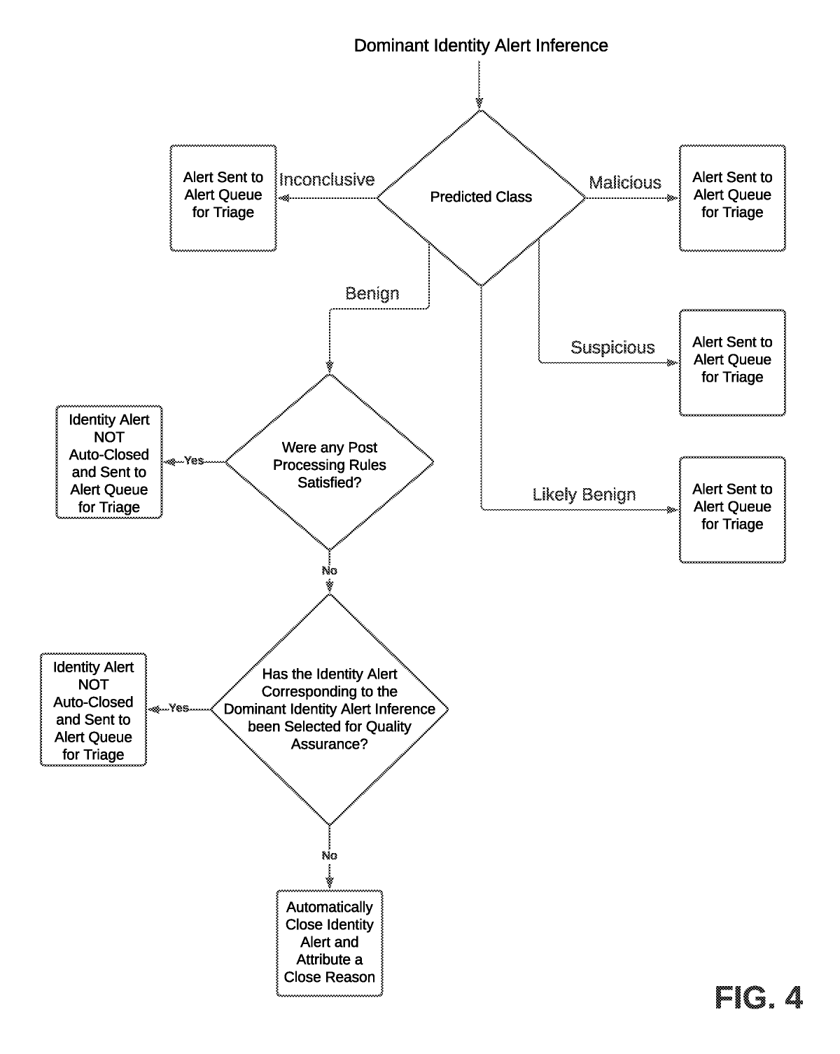

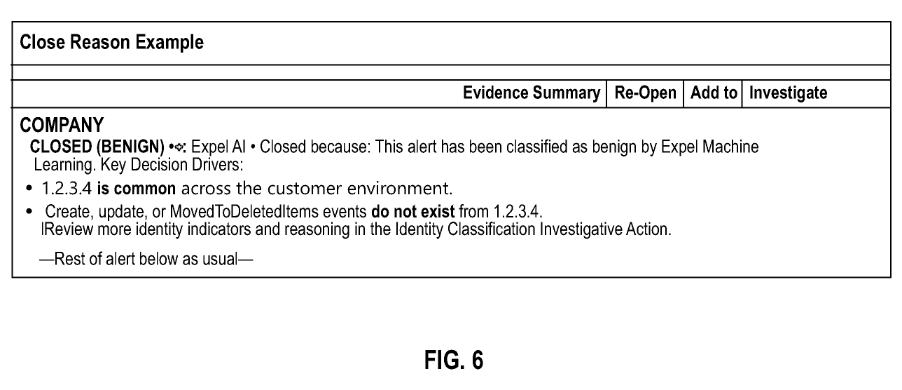

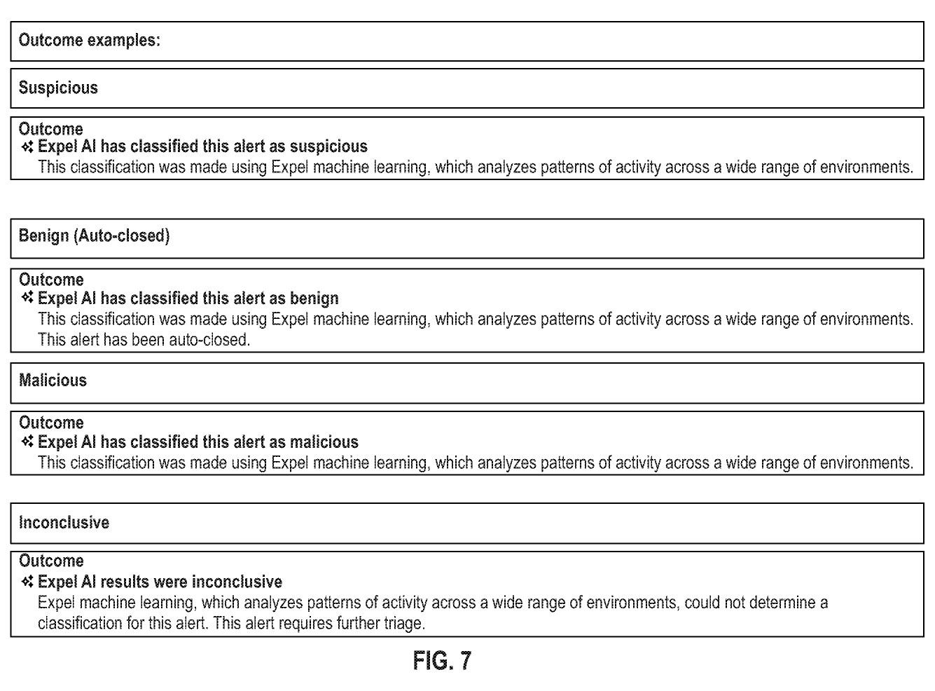

Accordingly, in one or more embodiments, the system or service implementing method 200 may function to automatically assess the confidence score (e.g., probability) of the prevailing or dominant identity alert inference against a minimum identity alert handling threshold. The minimum identity alert handling threshold, in one or more embodiments, may be set to 0.8, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, or 0.99. In such an embodiment, S240 may function to automatically close the subject identity alert when the confidence score of the prevailing or dominant identity alert inference satisfies the minimum identity alert handling threshold, as shown generally by way of example in FIG. 3, FIG. 4, FIG. 6, and FIG. 7. In such an embodiment, closing the subject identity alert may include attributing a close reason to the subject identity alert, such as “Closed by Expel Automation: This alert has been classified as benign based on historical data and machine learning” and/or removing the subject identity alert from any alert queue, list, or collection of active or open identity alerts awaiting a security triage, security investigation, or the like.

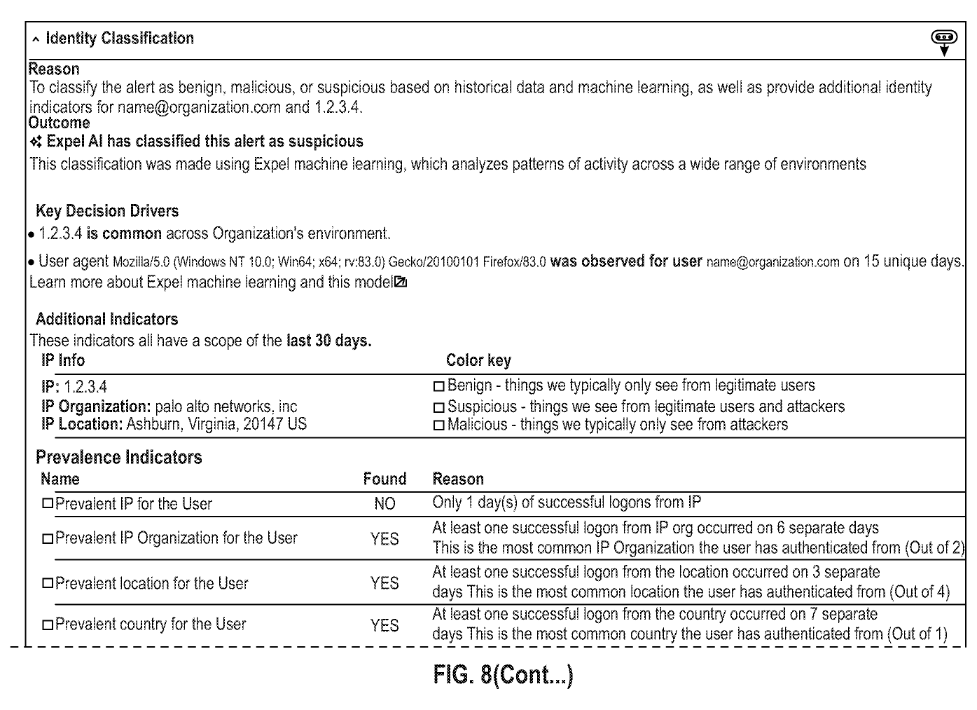

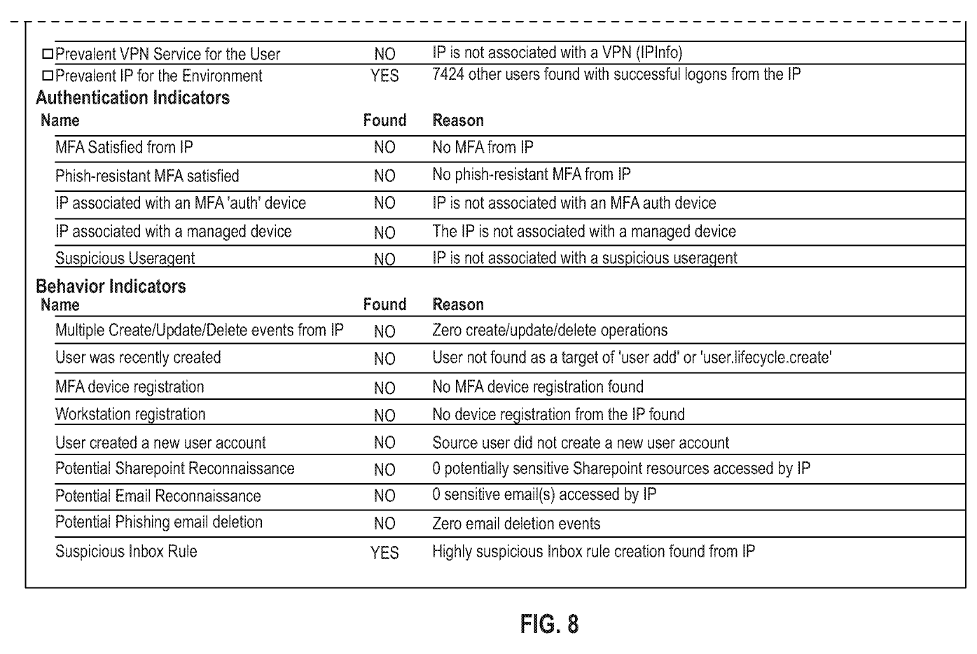

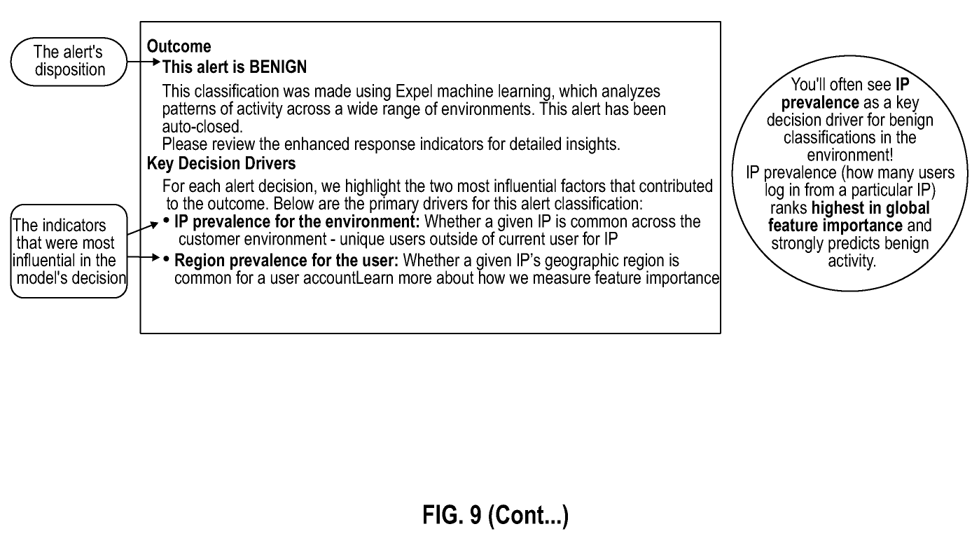

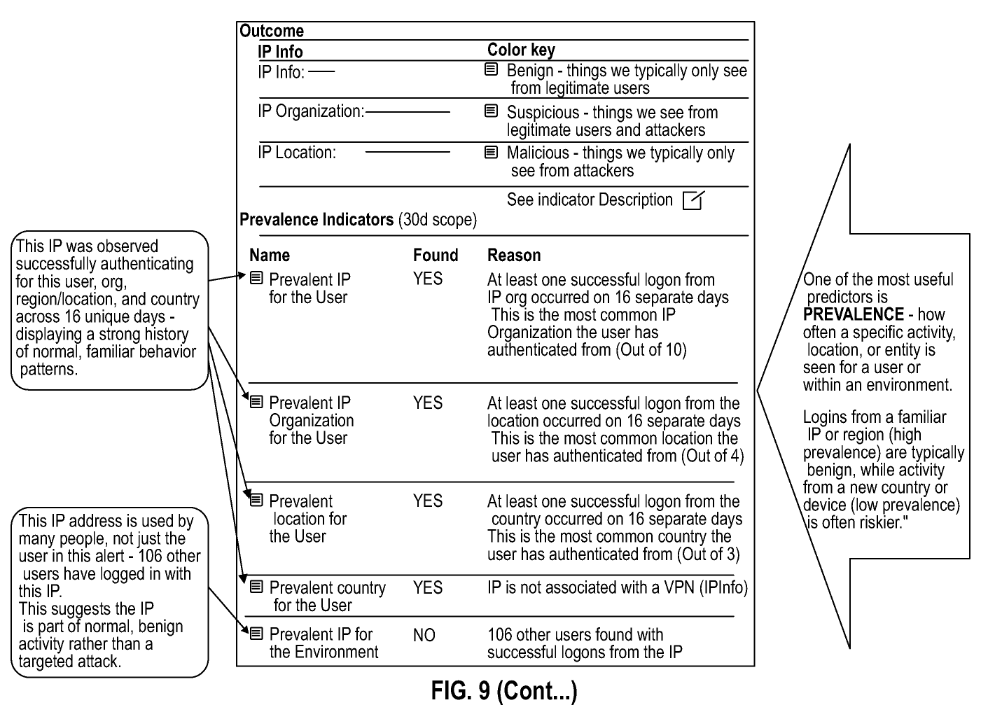

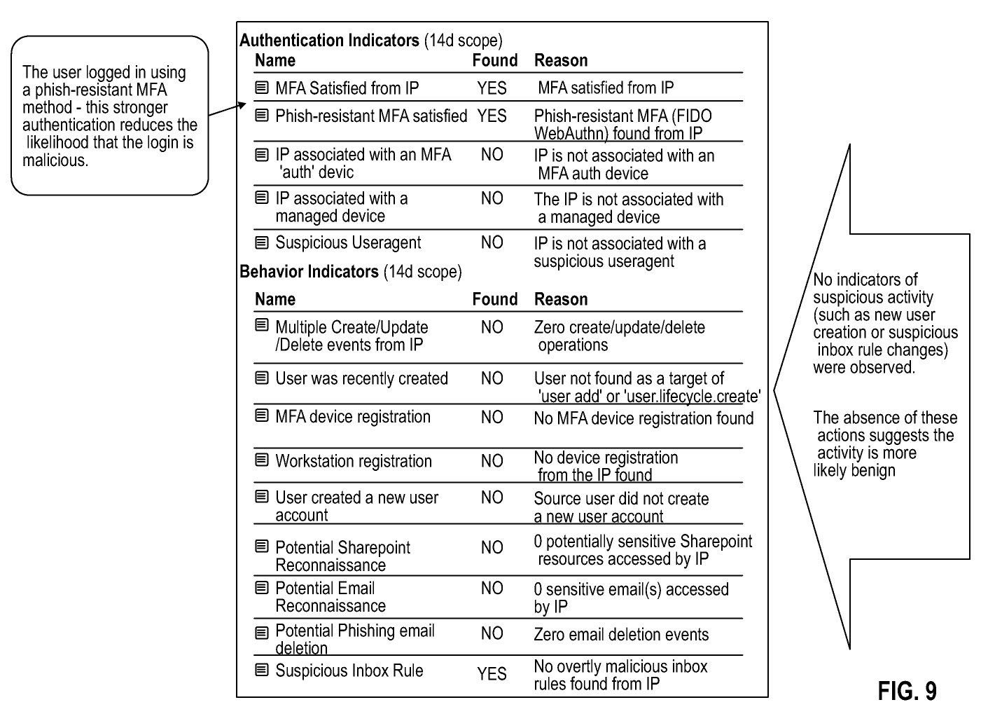

Conversely, in one or more embodiments, when the confidence score (e.g., probability) of the prevailing or dominant identity alert inference does not satisfy the minimum identity alert handling threshold, S240 may function to surface the subject identity alert for additional security review. In such an embodiment, S240 may function to display, present, or otherwise render a representation of the subject identity alert on a graphical user interface accessible to a user, analyst, operator, or security professional. The representation of the subject identity alert displayed on the graphical user interface may include, for example, one or more attributes or metadata associated with the subject identity alert, the confidence scores (e.g., probabilities) generated by the first and second machine learning models, the prevailing or dominant identity alert inference, and the top two contributing features that most significantly influenced the prevailing or dominant identity alert inference. In this manner, the user interface may provide meaningful transparency and explainability to assist a user or analyst in understanding the factors that contributed to the characterization of the subject identity alert and accelerate a security triaging for the subject identity alert, as shown generally by way of example in FIG. 8 and FIG. 9.

### Executing Automated Identity Alert Threat Mitigation Actions or Automated Identity Alert Disposal Actions for an Identity Alert in Real- Time or Near Real-Time

In one or more embodiments, the system or service implementing method 200 may function to obtain, using one or more processors, an identity alert associated with a subscribing entity and, in response, generate an identity alert feature vector for the identity alert based in part on alert data corresponding to the identity alert. The identity alert feature vector may include the feature value of the internet protocol address user prevalence feature value computed for the identity alert, the feature value of the internet protocol address environment prevalence feature computed for the identity alert, the feature value of the internet protocol address organization prevalence feature computed for the identity alert, the feature value for the ASN prevalence feature computed for the identity alert, the feature value of the geographical region prevalence feature computed for the identity alert, the feature value of the VPN user prevalence feature computed for the identity alert, the feature value of the VPN environment prevalence feature computed for the identity alert, the feature value of the hosting user prevalence feature computed for the identity alert, the feature value of the deletion event feature computed for the identity alert, the feature value of the consecutive MFA failure feature computed for the identity alert, the feature value of the malicious attribute feature computed for the identity alert, the feature value of the MFA device IP association feature computed for the identity alert, the feature value for the valid MFA device feature computed for the identity alert, the feature value of the strong MFA device feature computed for the identity alert, the feature value of the weak MFA device feature computed for the identity alert, the feature value of the user agent feature computed for the identity alert, the feature value of the user travel details feature computed for the identity alert, the feature value of the suspicious electronic inbox rule creation feature computed for the identity alert, the feature value of the new MFA device registration feature computed for the identity alert, the feature value of the deletion events from user and IP address feature computed for the identity alert, the feature value of the geo-impossible travel feature computed for the identity alert, the feature value of the new user account feature computed for the identity alert, each feature value of the one or more electronic communication features computed for the identity alert, the feature value of the new user agent feature computed for the identity alert, and/or the feature value of any other feature described herein.

In one or more embodiments, the system or service implementing method 200 may function to compute, using an ensemble of identity alert machine learning classification models, a plurality of distinct identity alert threat inferences for the identity alert based on providing the identity alert feature vector as input to each identity alert machine learning classification model included in the ensemble of identity alert machine learning classification models. In such an embodiment, computing the plurality of distinct identity alert threat inferences may include (i) computing, using a first identity alert machine learning classification model (e.g., first machine learning model or the like) of the ensemble of identity alert machine learning classification models, a first identity alert threat inference that includes a probability of the identity alert being a non-malicious identity alert and (ii) computing, using a second identity alert machine learning classification model (e.g., second machine learning model or the like) of the ensemble of identity alert machine learning classification models, a second identity alert threat inference that includes a probability of the identity alert being a benign identity alert.

In one or more embodiments, in response to computing the plurality of distinct identity alert threat inferences for the identity alert, the system or service implementing method 200 may function to elect, in real-time or near real-time using the one or more processors, one of the first identity alert threat inference and the second identity alert threat inference as a dominant identity alert threat inference for the identity alert based on assessing the probability of the identity alert being the non-malicious identity alert against the probability of the identity alert being the benign identity alert. In a non-limiting example, the system or service implementing method 200 may elect the first identity alert threat inference as the dominant identity alert threat inference when the probability of the identity alert being the non-malicious identity alert is greater than the probability of the identity alert being the benign identity alert. In another non-limiting example, the system or service implementing method 200 may elect the second identity alert threat inference as the dominant identity alert threat inference when the probability of the identity alert being the benign identity alert is greater than the probability of the identity alert being the non-malicious identity alert. Accordingly, in one or more embodiments, in response to electing the one of the first identity alert threat inference and the second identity alert threat inference as the dominant identity alert threat inference, the system or service implementing method 200 may function to automatically execute, based on the dominant identity alert threat inference, one or more identity alert threat mitigation actions or one or more identity alert disposal actions for the identity alert in real-time or near real-time.

For instance, in a non-limiting example, the dominant identity alert threat inference corresponds to the first identity alert threat inference and the probability of the identity alert being the non-malicious identity alert fails to satisfy a predetermined minimum threshold (e.g., the minimum identity alert handling threshold or the like). In such a non-limiting example, based on detecting that the probability of the identity alert being the non-malicious identity alert fails to satisfy the predetermined minimum threshold, the system or service implementing method 200 may execute the one or more identity alert threat mitigation actions. Executing the one or more identity alert threat mitigation actions, in such a non-limiting example may include attributing, based on the probability of the identity alert being the non-malicious identity alert, a threat severity classification label of a plurality of predetermined threat severity classification labels (e.g., malicious, suspicious, likely benign, benign, or inconclusive) to the identity alert and displaying the identity alert in association with the threat severity classification label on a graphical user interface.

Additionally, in one or more embodiments, the identity alert may specify a user account and, in turn, executing the one or more identity alert threat mitigation actions may further include detecting, based on an assessment of the graphical user interface, that the user account is compromised and, in response, automatically disabling, in real-time or near real-time, the user account to prevent unauthorized access to one or more computing environments of the subscribing entity using the user account. Additionally, or alternatively, executing the one or more identity alert threat mitigation actions may further include automatically resetting, in real-time or near real-time, one or more authentication credentials (e.g., username, password, etc.) associated with the user account to mitigate an active security threat involving the user account within one or more computing environments of the subscribing entity.

It shall be recognized that, in one or more embodiments, the graphical user interface may further include and/or display an identity alert explainability user interface object that includes a plurality of prevalence-based threat indicators derived from the identity alert, a plurality of authentication-based threat indicators derived from the identity alert, a plurality of behavioral-based threat indicators derived from the identity alert, as shown generally by way of example in FIG. 8 and FIG. 9. In such an embodiment, the system or service may function to detect, using the one or more processors, that (i) at least one threat indicator included in the plurality of prevalence-based threat indicators, the plurality of authentication-based threat indicators, or the plurality of behavioral-based threat indicators indicates malicious activity, (ii) at least one threat indicator included in the plurality of prevalence-based threat indicators, the plurality of authentication-based threat indicators, or the plurality of behavioral-based threat indicators indicates suspicious activity, and at least one threat indicator included in the plurality of prevalence-based threat indicators, the plurality of authentication-based threat indicators, or the plurality of behavioral-based threat indicators indicates benign activity and, in response, the graphical user interface may display (a) the at least one threat indicator indicative of malicious activity in a first distinct color (e.g., red) when the at least one threat indicator indicates malicious activity, (b) the at least one threat indicator indicative of suspicious activity in a second distinct color (e.g., yellow) when the at least one threat indicator indicates suspicious activity, and (c) the at least one threat indicator indicative of benign activity in a third distinct color (e.g., green) when the at least one threat indicator indicates benign activity. At least one technical benefit of such an embodiment includes improving graphical user interface usability by displaying identity alert threat indicators in distinct colors corresponding to malicious, suspicious, and benign activity, thereby reducing alert interpretation time and enabling quicker identification of identity alerts requiring threat mitigation actions.

It shall be recognized that the system or service implementing method 200 may function to perform additional automated threat mitigation actions, as described in in U.S. Patent Application No. 19/185,816, titled SYSTEMS AND METHODS FOR ACCELERATED REMEDIATIONS OF CYBERSECURITY ALERTS AND CYBERSECURITY EVENTS IN A CYBERSECURITY EVENT DETECTION AND RESPONSE PLATFORM, which is incorporated herein in its entirety by this reference.

In another non-limiting example, the dominant identity alert threat inference may correspond to the second identity alert threat inference and the probability of the identity alert being the benign identity alert may satisfy the predetermined minimum threshold (e.g., the minimum identity alert handling threshold or the like). In such a non-limiting example, based on detecting that the probability of the identity alert being the benign identity alert satisfies the predetermined minimum threshold, the system or service implementing method 200 may function to execute the one or more identity alert disposal actions. Executing the one or more identity alert disposal actions, in one or more embodiments, may include automatically closing, in real-time, the identity alert to prevent a security analyst from at least one of investigating, reviewing, and escalating the identity alert and/or automatically attributing, in real-time, a close reason to the identity alert indicating that the identity alert is benign. At least one technical benefit of automatically closing identity alerts includes preventing benign identity alerts from entering or persisting in analyst-facing review and response workflows, thereby conserving system resources and improving the efficiency of identity threat detection operations.

It shall be recognized that, in one or more embodiments, the system or service implementing method 200 may function to detect, in response to assessing the dominant identity alert threat inference, that the identity alert is eligible to be automatically closed. In such an embodiment, in response to detecting that the identity alert is eligible to be automatically closed, the system or service implementing method 200 may function to assess the identity alert feature vector against one or more post-processing rules. Accordingly, the system or service implementing method 200 may function to detect, in response to assessing the identity alert feature vector against the one or more post-processing rules, that at least one feature value corresponding to at least one feature included in the identity alert feature vector is suspicious and, in turn, prevent automatic closure of the identity alert based on detecting that the at least one feature value corresponding to the at least one feature is suspicious, as shown generally by way of example in FIG. 4.

### Training the First Identity Alert Machine Learning Classification Model

In one or more embodiments, the system or service implementing method 200 may function to obtain, from a computer database, an initial set of historical identity alerts that occurred in a target period and, in response, extract, from the initial set of historical identity alerts, (i) a first subset of malicious historical identity alerts that includes all malicious identity alerts that occurred in the target period and (ii) a second subset of non-malicious historical identity alerts that includes all non-malicious identity alerts that occurred in the target period. In such an embodiment, the system or service implementing method 200 may function to execute, on the second subset of non-malicious historical identity alerts, a stratified sampling process to generate a reduced subset of historical non-malicious identity alerts. Furthermore, in such an embodiment, the system or service implementing method 200 may function to configure a training data corpus that includes the first subset of malicious historical identity alerts and the reduced subset of historical non-malicious identity alerts, wherein: each malicious identity alert included in the first subset of malicious historical identity alerts is attributed a malicious identity alert classification label, and each non-malicious identity alert included in the reduced subset of historical non-malicious identity alerts is attributed a non-malicious identity alert classification label. Accordingly, in one or more embodiments, the system or service implementing method 200 may function to configure the first identity alert machine learning classification model based on training an extreme gradient boosting (XGBoost) machine learning model using the training data corpus.

It shall be recognized that, in one or more embodiments, the training data corpus may be configured such that a ratio of non-malicious identity alerts to malicious identity alerts included in the training data corpus is three to one.

It shall be further recognized that, in one or more embodiments, the target period corresponds to a target year and the reduced subset of historical non-malicious identity alerts includes: a first set of historical non-malicious identity alerts that occurred in a first month of the target year, a second set of historical non-malicious identity alerts that occurred in a second month of the target year, a third set of historical non-malicious identity alerts that occurred in a third month of the target year, a fourth set of historical non-malicious identity alerts that occurred in a fourth month of the target year, a fifth set of historical non-malicious identity alerts that occurred in a fifth month of the target year, a sixth set of historical non-malicious identity alerts that occurred in a sixth month of the target year, a seventh set of historical non-malicious identity alerts that occurred in a seventh month of the target year, an eighth set of historical non-malicious identity alerts that occurred in an eighth month of the target year, a ninth set of historical non-malicious identity alerts that occurred in a ninth month of the target year, a tenth set of historical non-malicious identity alerts that occurred in a tenth month of the target year, an eleventh set of historical non-malicious identity alerts that occurred in an eleventh month of the target year, and a twelfth set of historical non-malicious identity alerts that occurred in a twelfth month of the target year. Accordingly, in such an embodiment, a total number of non-malicious identity alerts included in the reduced subset that occurred in a respective month of the target year is equal to a total number of non-malicious identity alerts included in the reduced subset that occurred in any other month of the target year.

### Training the Second Identity Alert Machine Learning Classification Model

In one or more embodiments, the system or service implementing method 200 may function to obtain, from a computer database, an initial set of historical identity alerts that occurred in a target period and, in response, extract, from the initial set of historical identity alerts, (i) a first subset of not benign historical identity alerts that includes all identity alerts that occurred in the target period that were determined to be not benign alerts and (ii) a second subset of benign historical identity alerts that includes all identity alerts that occurred in the target period that were determined to be benign alerts. In such an embodiment, the system or service implementing method 200 may function to execute, on the second subset of benign historical identity alerts, a stratified sampling process to generate a reduced subset of benign historical identity alerts. Furthermore, in such an embodiment, the system or service implementing method 200 may function to configure a training data corpus that includes the first subset of not benign historical identity alerts and the reduced subset of benign historical identity alerts, wherein each identity alert included in the first subset of not benign historical identity alerts is attributed a not benign identity alert classification label, and each identity alert included in the reduced subset of benign historical identity alerts is attributed a benign identity alert classification label. Accordingly, the system or service implementing method 200 may function to configure the second identity alert machine learning classification model based on training an extreme gradient boosting (XGboost) machine learning model using the training data corpus.

It shall be recognized that, in one or more embodiments, the training data corpus is configured such that a ratio of benign identity alerts to not benign identity alerts included in the training data corpus is three to one.

It shall be further recognized that, in one or more embodiments, the target period corresponds to a target year. In such an embodiment, the reduced subset of benign historical identity alerts includes a distinct set of benign identity alerts that occurred in each month of the target year. Furthermore, in such an embodiment, a total number of benign identity alerts included in the reduced subset that occurred in a respective month of the target year is equal to a total number of benign identity alerts included in the reduced subset that occurred in any other month of the target year.

### 3. Computer-Implemented Method and Computer Program Product

Embodiments of the system and/or method can include every combination and permutation of the various system components and the various method processes, wherein one or more instances of the method and/or processes described herein can be performed in real-time or near real-time, asynchronously (e.g., sequentially), concurrently (e.g., in parallel), or in any other suitable order by and/or using one or more instances of the systems, elements, and/or entities described herein.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although omitted for conciseness, the embodiments include every combination and permutation of the implementations of the systems and methods described herein. Furthermore, each method step, process step, or the like described herein may be performed in real-time or near real-time. It shall be noted that “real-time” or “near real-time” as generally used herein may refer to generating an output or performing an action within strict time constraints. For example, in one or more embodiments, real-time may be understood to be instantaneous, on the order of milliseconds, or on the order of minutes. Of course, depending on the particular temporal nature of the system in which an embodiment is implemented, other appropriate timescales may be considered acceptable for real-time or near real-time processing.

As a person skilled in the art will recognize from the previous detailed description and from the figures and claims, modifications and changes can be made to the preferred embodiments of the invention without departing from the scope of this invention defined in the following claims.

We claim:

1. A computer-implemented method comprising:
obtaining, using one or more processors, an identity alert associated with a subscribing entity;
generating, in response to obtaining the identity alert, an identity alert feature vector for the identity alert based in part on alert data corresponding to the identity alert;
computing, using an ensemble of identity alert machine learning classification models, a plurality of distinct identity alert threat inferences for the identity alert
based on providing the identity alert feature vector as input to each identity alert machine learning classification model included in the ensemble of identity alert machine learning classification models, wherein computing the plurality of distinct identity alert threat inferences includes:
computing, using a first identity alert machine learning classification model of the ensemble of identity alert machine learning classification models, a first identity alert threat inference that includes a probability of the identity alert being a non-malicious identity alert, and
computing, using a second identity alert machine learning classification model of the ensemble of identity alert machine learning classification models, a second identity alert threat inference that includes a probability of the identity alert being a benign identity alert;
electing, using the one or more processors, one of the first identity alert threat inference and the second identity alert threat inference as a dominant identity alert threat inference for the identity alert based on assessing the probability of the identity alert being the non-malicious identity alert against the probability of the identity alert being the benign identity alert; and
in response to electing the one of the first identity alert threat inference and the second identity alert threat inference as the dominant identity alert threat inference, automatically executing, based on the dominant identity alert threat inference, one or more identity alert threat mitigation actions or one or more identity alert disposal actions for the identity alert in real-time or near real-time.

2. The computer-implemented method according to claim 1, wherein:
the dominant identity alert threat inference corresponds to the first identity alert threat inference,
the probability of the identity alert being the non-malicious identity alert fails to satisfy a predetermined minimum threshold, and
automatically executing the one or more identity alert threat mitigation actions or the one or more identity alert disposal actions for the identity alert includes executing the one or more identity alert threat mitigation actions based on detecting that the probability of the identity alert being the non-malicious identity alert fails to satisfy the predetermined minimum threshold, wherein executing the one or more identity alert threat mitigation actions includes:
attributing, based on the probability of the identity alert being the non-malicious identity alert, a threat severity classification label of a plurality of predetermined threat severity classification labels to the identity alert; and
displaying the identity alert in association with the threat severity classification label on a graphical user interface.

3. The computer-implemented method according to claim 2, wherein:
the identity alert specifies a user account, and
executing the one or more identity alert threat mitigation actions further includes:
detecting, based on an assessment of the graphical user interface, that the user account is compromised, and
in response to detecting that the user account is compromised, automatically disabling, in real-time or near real-time, the user account to prevent unauthorized access to one or more computing environments of the subscribing entity using the user account.

4. The computer-implemented method according to claim 2, wherein:
the identity alert specifies a user account, and
executing the one or more identity alert threat mitigation actions further includes:
detecting, based on an assessment of the graphical user interface, that the user account is compromised, and
in response to detecting that the user account is compromised, automatically resetting, in real-time or near real-time, one or more authentication credentials of the user account to mitigate an active security threat involving the user account within one or more computing environments of the subscribing entity.

5. The computer-implemented method according to claim 2, wherein:
the graphical user interface further includes an identity alert explainability user interface object displayed in association with the identity alert, wherein the identity alert explainability user interface object includes:
a plurality of prevalence-based threat indicators derived from the identity alert,
a plurality of authentication-based threat indicators derived from the identity alert, and
a plurality of behavioral-based threat indicators derived from the identity alert.

6. The computer-implemented method according to claim 5, further comprising:
detecting, using the one or more processors, that at least one threat indicator included in the plurality of prevalence-based threat indicators, the plurality of authentication-based threat indicators, or the plurality of behavioral-based threat indicators indicates malicious activity;
detecting, using the one or more processors, that at least one threat indicator included in the plurality of prevalence-based threat indicators, the plurality of authentication-based threat indicators, or the plurality of behavioral-based threat indicators indicates suspicious activity; and
detecting, using the one or more processors, that at least one threat indicator included in the plurality of prevalence-based threat indicators, the plurality of authentication-based threat indicators, or the plurality of behavioral-based threat indicators indicates benign activity, wherein the graphical user interface displays:
the at least one threat indicator indicative of malicious activity in a first distinct color when the at least one threat indicator indicates malicious activity,
the at least one threat indicator indicative of suspicious activity in a second distinct color when the at least one threat indicator indicates suspicious activity, and
the at least one threat indicator indicative of benign activity in a third distinct color when the at least one threat indicator indicates benign activity.

7. The computer-implemented method according to claim 1, wherein:
the dominant identity alert threat inference corresponds to the second identity alert threat inference,
the probability of the identity alert being the benign identity alert satisfies a predetermined minimum threshold, and
automatically executing the one or more identity alert threat mitigation actions or the one or more identity alert disposal actions for the identity alert includes executing the one or more identity alert disposal actions based on detecting that the probability of the identity alert being the benign identity alert satisfies the predetermined minimum threshold, wherein executing the one or more identity alert disposal actions includes:
automatically closing, in real-time, the identity alert to prevent a security analyst from at least one of investigating, reviewing, and escalating the identity alert, and
automatically attributing, in real-time, a close reason to the identity alert indicating that the identity alert is benign.

8. The computer-implemented method according to claim 1, further comprising:
detecting, in response to assessing the dominant identity alert threat inference, that the identity alert is eligible to be automatically closed;
in response to detecting that the identity alert is eligible to be automatically closed, assessing the identity alert feature vector against one or more post-processing rules;
detecting, in response to assessing the identity alert feature vector against the one or more post-processing rules, that at least one feature value corresponding to at least one feature included in the identity alert feature vector is suspicious; and
preventing automatic closure of the identity alert based on detecting that the at least one feature value corresponding to the at least one feature is suspicious.

9. The computer-implemented method according to claim 1, further comprising:
obtaining, from a computer database, an initial set of historical identity alerts that occurred in a target period;
extracting, from the initial set of historical identity alerts, (i) a first subset of malicious historical identity alerts that includes all malicious identity alerts that occurred in the target period and (ii) a second subset of non-malicious historical identity alerts that includes all non-malicious identity alerts that occurred in the target period;
executing, on the second subset of non-malicious historical identity alerts, a stratified sampling process to generate a reduced subset of historical non-malicious identity alerts;
configuring a training data corpus that includes the first subset of malicious historical identity alerts and the reduced subset of historical non-malicious identity alerts, wherein:
each malicious identity alert included in the first subset of malicious historical identity alerts is attributed a malicious identity alert classification label, and
each non-malicious identity alert included in the reduced subset of historical non-malicious identity alerts is attributed a non- malicious identity alert classification label; and
configuring the first identity alert machine learning classification model based on a training of an extreme gradient boosting (XGBoost) machine learning model using the training data corpus.

10. The computer-implemented method according to claim 9, wherein:
the training data corpus is configured such that a ratio of non-malicious identity alerts to malicious identity alerts included in the training data corpus is three to one.

11. The computer-implemented method according to claim 9, wherein:
the target period corresponds to a target year,
the reduced subset of historical non-malicious identity alerts includes a first set of historical non-malicious identity alerts that occurred in a first month of the target year, a second set of historical non-malicious identity alerts that occurred in a second month of the target year, a third set of historical non-malicious identity alerts that occurred in a third month of the target year, a fourth set of historical non-malicious identity alerts that occurred in a fourth month of the target year, a fifth set of historical non-malicious identity alerts that occurred in a fifth month of the target year, a sixth set of historical non-malicious identity alerts that occurred in a sixth month of the target year, a seventh set of historical non-malicious identity alerts that occurred in a seventh month of the target year, an eighth set of historical non-malicious identity alerts that occurred in an eighth month of the target year, a ninth set of historical non-malicious identity alerts that occurred in a ninth month of the target year, a tenth set of historical non-malicious identity alerts that occurred in a tenth month of the target year, an eleventh set of historical non-malicious identity alerts that occurred in an eleventh month of the target year, and a twelfth set of historical non-malicious identity alerts that occurred in a twelfth month of the target year, and
a total number of non-malicious identity alerts included in the reduced subset that occurred in a respective month of the target year is equal to a total number of non-malicious identity alerts included in the reduced subset that occurred in any other month of the target year.

12. The computer-implemented method according to claim 1, further comprising:
obtaining, from a computer database, an initial set of historical identity alerts that occurred in a target period;
extracting, from the initial set of historical identity alerts, (i) a first subset of not benign historical identity alerts that includes all identity alerts that occurred in the target period that were determined to be not benign alerts and (ii) a second subset of benign historical identity alerts that includes all identity alerts that occurred in the target period that were determined to be benign alerts;
executing, on the second subset of benign historical identity alerts, a stratified sampling process to generate a reduced subset of benign historical identity alerts;
configuring a training data corpus that includes the first subset of not benign historical identity alerts and the reduced subset of benign historical identity alerts, wherein:
each identity alert included in the first subset of not benign historical identity alerts is attributed a not benign identity alert classification label, and
each identity alert included in the reduced subset of benign historical identity alerts is attributed a benign identity alert classification label; and
configuring the second identity alert machine learning classification model based on a training of an extreme gradient boosting (XGBoost) machine learning model using the training data corpus.

13. The computer-implemented method according to claim 12, wherein:
the training data corpus is configured such that a ratio of benign identity alerts to not benign identity alerts included in the training data corpus is three to one,
the target period corresponds to a target year,
the reduced subset of benign historical identity alerts includes a distinct set of benign identity alerts that occurred in each month of the target year, and
a total number of benign identity alerts included in the reduced subset that occurred in a respective month of the target year is equal to a total number of benign identity alerts included in the reduced subset that occurred in any other month of the target year.

14. The computer-implemented method according to claim 1, wherein:
the identity alert is associated with a digital user,
the identity alert feature vector includes:
a feature value for a first feature, wherein the feature value for the first feature specifies a total number of unique days, during a historical time span, that the digital user successfully logged into a computing environment of the subscribing entity from an internet protocol address specified in the identity alert,
a feature value for a second feature, wherein the feature value for the second feature specifies an authentication success rate observed for the
digital user during the historical time span,
a feature value for a third feature, wherein the feature value for the third feature specifies a total number of unique users, during the historical time span, that successfully authenticated into the computing environment of the subscribing entity from the internet protocol address specified in the identity alert, and
a feature value for a fourth feature, wherein the feature value for the fourth feature specifies a total number of times, during the historical time span, that the digital user successfully authenticated into the computing environment from a geographical location determined based on the internet protocol address specified in the identity alert.

15. The computer-implemented method according to claim 1, wherein:
the identity alert is associated with a digital user,
the computer-implemented method further comprises:
detecting, by the one or more processors, that the digital user used a virtual private network while logging into a computing environment of the subscribing entity;
determining, by the one or more processors, a total number of times, during a historical time span, that the digital user successfully authenticated to the computing environment from the virtual private network; and
determining, by the one or more processors, a total number of unique digital users that have successfully authenticated into the computing environment from the virtual private network during the historical time span, and
the identity alert feature vector includes:
a feature value for a first feature, wherein the feature value for the first feature specifies the total number of times, during the historical time span, that the digital user successfully authenticated to the computing environment from the virtual private network, and
a feature value for a second feature, wherein the feature value for the second feature specifies the total number of unique digital users that have successfully authenticated into the computing environment from the virtual private network during the historical time span.

16. The computer-implemented method according to claim 1, wherein:
the identity alert is associated with a digital user,
the computer-implemented method further comprises:
identifying, based on assessing log data associated with the subscribing entity, one or more deletion events attributable to the digital user that occurred during a historical time span, wherein each deletion event of the one or more deletion events corresponds to a distinct action by the digital user that removes, destroys, or eliminates data within a computing environment of the subscribing entity;
determining, based on the one or more deletion events, a total number of deletion events attributable to the digital user during the historical time span, and
the identity alert feature vector includes:
a feature value for a subject feature, wherein the feature value for the subject feature specifies the total number of deletion events attributable to the digital user during the historical time span.

17. The computer-implemented method according to claim 1, wherein:
the identity alert is associated with a user,
the computer-implemented method further comprises:
automatically determining, based on assessing log data associated with the subscribing entity, whether one or more travel-related indicators for the user appear in the log data;
computing, based on the automatic determining, a feature value for a user travel details feature, wherein:
the feature value for the user travel details feature is one when at least one travel-related text string for the user is detected in the log data, and
the feature value for the user travel details feature is zero when no travel-related text string for the user is detected in the log data, and
the identity alert feature vector includes the feature value for the user travel details feature.

18. The computer-implemented method according to claim 1, wherein:
the identity alert is associated with a digital user,
the computer-implemented method further comprises:
detecting, based on assessing log data associated with the subscribing entity, that the digital user created at least one electronic inbox rule during a predetermined time span;
assessing, in response to detecting that the digital user created the at least one electronic inbox rule during the predetermined time span, whether the at least one electronic inbox rule satisfies a suspicious electronic inbox rule criterion; and
computing, based on the assessing of the at least one electronic inbox rule, a feature value for a suspicious electronic inbox rule creation feature, wherein:
the feature value for the suspicious electronic inbox rule creation feature is one when the at least one electronic inbox rule satisfies the suspicious electronic inbox rule criterion, and
the feature value for the suspicious electronic inbox rule creation feature is zero when the at least one electronic inbox rule fails to satisfy the suspicious electronic inbox rule criterion, and
the identity alert feature vector includes the feature value for the suspicious electronic inbox rule creation feature.

19. The computer-implemented method according to claim 1, wherein:
the identity alert is associated with a user,
the computer-implemented method further comprises:
obtaining, based on assessing authentication log data associated with the subscribing entity, a plurality of login events corresponding to the user that occurred within a predetermined time span;
constructing, based on obtaining the plurality of login events, an authentication event sequence data structure for the user that includes the plurality of login events in chronological order;
assessing at least one pair of sequential login events included in the authentication event sequence data structure to determine whether travel between (i) a first distinct geographical location associated with a first login event included in the at least one pair of sequential login events and (ii) a second distinct geographic location associated with a second login event included in the at least one pair of sequential login events is physically possible based on an amount of time elapsed between the first login event and the second login event;
computing, based on the assessing of the least one pair of sequential login events, a feature value for a subject feature, wherein:
the feature value of the subject feature is one when the at least one pair of sequential login events requires travel by the user from the first distinct geographical location to the second distinct geographic location at a speed that exceeds a predetermined maximum travel speed threshold, and
the feature value of the subject feature is zero when the at least one pair of sequential login events requires travel by the user from the first distinct geographical location to the second distinct geographic location at the speed that does not exceed the predetermined maximum travel speed threshold, and
the identity alert feature vector includes the feature value for the subject feature.

20. The computer-implemented method according to claim 1, wherein:
a model structure of the first identity alert machine learning classification model is different from a model structure of the second identity alert machine learning classification model, and
a set of weights and biases used by the first identity alert machine learning classification model to compute the probability of the identity alert being the non-malicious identity alert is different from a set of weights and biases used by the second identity alert machine learning classification model to compute the probability of the identity alert being the benign identity alert.
